(19) United States
(12) Patent Application Publication
(10) Pub. No.: US 2026/0121370 A1
(43) Pub. Date: Apr. 30, 2026

(54) CONFIGURING OPTICAL AMPLIFICATION MODULES AND OPTICAL POWER SPLITTING MODULES

(71) Applicant: Ayo Electronics Inc., Boston, MA (US)

(72) Inventors: Peter Nicholas Russo, Arlington, MA (US); Michael Gould, Newjport, VT (US)

(73) Assignee: Ayo Electronics Inc., Boston, MA (US)

(21) Appl. No.: 19/368,132

(22) Filed: Oct. 24, 2025

Related U.S. Application Data
(60) Provisional application No. 63/713,228, filed on Oct. 29, 2024.

(51) Int. Cl. H01S 3/23

(52) U.S. Cl. CPC H01S 3/2316

(57) ABSTRACT

An apparatus comprises: an input port configured to receive an optical wave; a plurality of optical amplification modules (OAMs), each configured to apply a gain to an optical wave; a plurality of optical power splitting modules (OPSMs), each configured to provide portions of an optical wave to two or more outputs according to an optical power splitting ratio; and a plurality of optical ports, each configured to provide an optical wave; wherein the plurality of OPSMs is interconnected in a tree network that comprises: a root stage comprising a path segment between the input port and a first OPSM, a final stage comprising a plurality of path segments between OPSMs and optical ports, and a plurality of inner stages, each comprising a plurality of path segments between an upstream and a downstream OPSM; and wherein at least two inner stages each include an OAM on one or more path segments.

### CROSS-REFERENCE TO RELATED APPLICATION(S)

This application claims priority to and the benefit of U.S. Provisional Application Ser. No. 63/713,228, entitled “High Gain, Output Power, and Efficiency Semiconductor Optical Amplifier,” filed Oct. 29, 2024, the entire disclosure of which is incorporated herein by reference.

### TECHNICAL FIELD

This disclosure relates to configuring optical amplification modules and optical power splitting modules.

### BACKGROUND

Chip-scale devices and systems can be configured to generate, process, or manipulate optical signals, electrical signals, or some combination thereof. Some systems can comprise integrated circuits (ICs) that are configured for electrical or optical signal processing. IC devices have increasingly found applications in a range of fields. By way of example, IC devices have fields ranging from telecommunications, data communications, sensing, medical, aerospace, defense, and industrial manufacturing. Increasing demand for systems comprising ICs has driven advancements in their operating capabilities, physical sizes, and reliability alongside optimization of associated manufacturing processes including production and testing.

Some photonic processing devices can comprise semiconductor materials such as silicon or III/V compounds. Some examples of II/V compounds comprise elements from group III of the periodic table, such as boron, aluminum, gallium, or indium. Some examples of II/V compounds comprise elements from group V of the periodic table, such as nitrogen, phosphorous, arsenic, or antimony. In some implementations, semiconductor materials can be doped with p-type or n-type dopants. In some implementations n-type dopants can comprise elements such as tin, germanium, silicon, tellurium, and sulfur. In some implementations p-type dopants can comprise elements such as zinc, cadmium, beryllium, and magnesium.

Some photonic processing devices can comprise optical waveguiding structures or optical circuits configured to guide optical waves in the optical wavelength region of the electromagnetic spectrum. Some electromagnetic waves have a spectrum that has a peak wavelength that falls in a particular range of optical wavelengths (e.g., between about 100 nm to about 1 mm, or some subrange thereof), also referred to as optical waves, light waves, or simply light. In some implementations, optical waves can be associated with one or more optical modes or spatial modes. In some implementations, an optical mode can be associated with a structure that is configured to guide an optical wave.

Some systems can include optical amplifiers that are configured to amplify or apply a gain to optical waves. In other words, an optical amplifier can receive an input optical wave and apply a gain to the input optical wave to produce an output optical wave having a higher optical power according to the gain of the optical amplifier. In some implementations, an optical amplifier can be formed from a semiconductor material or semiconductor gain medium and integrated into an integrated circuit system or integrated circuit architecture. Some materials can apply gain to an optical wave based on external field applied to the material, such as an electrical field or an optical field. An optical amplifier formed from a semiconductor material or semiconductor gain medium can be referred to as a semiconductor optical amplifier (SOA). Some optical amplifiers can allow for optical signals in the form of optical waves to be amplified without converting the signals between optical and electronic domains, which can be associated with signal losses and increased power consumption of the system.

### SUMMARY

In one aspect, in general, an apparatus comprises: an input port configured to receive an optical wave; a plurality of optical amplification modules, each configured to apply a gain to an optical wave propagating through that optical amplification module; a plurality of optical power splitting modules, each configured to provide portions of an input optical wave to each output of two or more outputs according to an optical power splitting ratio associated with that optical power splitting module; a plurality of optical ports, each configured to provide an optical wave; and an optical combining arrangement configured to combine at least a portion of an optical wave from each optical port of two or more optical ports of the plurality of optical ports into one or more optical waves; wherein a first optical power splitting module of the plurality of optical power splitting modules is in optical communication with the input port; and wherein each optical power splitting module is configured to provide portions of an optical wave to at least one of (1) an optical port of the plurality of optical ports along a path comprising one or more optical amplification modules of the plurality of optical amplification modules, or (2) a different optical power splitting module of the plurality of optical power splitting modules along a path comprising one or more optical amplification modules of the plurality of optical amplification modules.

Aspects can include one or more of the following features.

The apparatus further comprises a plurality of phase modulation modules, where each phase modulation module of the plurality of phase modulation modules is configured to apply a phase modulation to an optical wave propagating through that phase modulation module of the plurality of phase modulation modules, and where each phase modulation module is in optical communication with an optical amplification module of the plurality of optical amplification modules or an optical power splitting module of the plurality of optical power splitting modules.

Each phase modulation module of the plurality of phase modulation modules is in optical communication with an optical port of the plurality of optical ports.

Each phase modulation module of the plurality of phase modulation modules is configured to apply the phase modulation in response to a control signal provided to that phase modulation module of the plurality of phase modulation modules.

One or more optical amplification modules of the plurality of optical amplification modules are further configured to apply a phase modulation to an optical wave propagating through that optical amplification module of the one or more optical amplification modules.

The plurality of optical power splitting modules are interconnected in a tree network, with each different path of a plurality of paths through the tree network including one or more optical amplification modules.

Each portion of a path through the tree network between two different optical power splitting modules includes at least one optical amplification module.

The first optical power splitting module of the plurality of optical power splitting modules is in optical communication with the input port along a path that includes an optical amplification module of the plurality of optical amplification modules.

Each optical amplification module of the plurality of optical amplification modules is configured to apply the gain to the optical wave in response to a control signal provided to that optical amplification module of the plurality of optical amplification modules.

The apparatus further comprises circuitry configured to provide a control signal to each optical amplification module of the plurality of optical amplification modules.

At least one control signal is generated based at least in part on a measurement of the optical wave produced by the optical combining arrangement.

The optical combining arrangement comprises a free-space optical combining arrangement configured to combine at least a portion of an optical wave from each optical port of the plurality of optical ports into a spatial mode of an optical wave.

The optical combining arrangement comprises a network of a plurality of optical combining modules, where each optical combining module of the plurality of optical combining modules is configured to receive at least two optical waves and combine the at least two optical waves into an optical wave.

The gain that each optical amplification module of the plurality of optical amplification modules applies to an optical wave is based at least in part on an optical power splitting ratio associated with an optical power splitting module of the plurality of optical power splitting modules that provides an optical wave to that optical amplification module of the plurality of optical amplification modules.

At least one path along which an optical power splitting module of the plurality of optical power splitting modules provides an optical wave has an optical path length that is different from an optical path length of a path along which a different optical power splitting module of the plurality of optical power splitting modules provides an optical wave.

The apparatus further comprises one or more filtering modules, where each filtering module of the one or more filtering modules is configured to separate optical waves propagating through that filtering module of the one or more filtering modules, and where each filtering module of the one or more filtering modules is in optical communication with an optical amplification module of the plurality of optical amplification modules or an optical power splitting module of the plurality of optical power splitting modules.

Each optical port of the two or more optical ports associated with the optical combining arrangement is in optical communication with an optical reflector such that the optical combining arrangement uses one or more optical power splitting modules of the plurality of optical power splitting modules to combine optical waves.

At least a first optical amplification module that receives an optical wave over a first path from the input port through one or more optical power splitting modules is configured to apply a gain that is less than twice an inverse of an optical power splitting ratio associated with an optical power splitting module that is either (1) upstream and closer to the first optical amplification module than all other optical power splitting modules upstream on the first path or (2) downstream and closer to the first optical amplification module than all other optical power splitting modules downstream on the first path.

In another aspect, in general, a method comprises: arranging an input port configured to receive an optical wave; arranging a plurality of optical power splitting modules, each configured to provide portions of an input optical wave to each output of two or more outputs according to an optical power splitting ratio associated with that optical power splitting module; arranging a plurality of optical amplification modules, each configured to apply a gain to an optical wave propagating through that optical amplification module; arranging a plurality of optical ports, each configured to provide an optical wave; configuring an optical combining arrangement to combine at least a portion of an optical wave from each optical port of two or more optical ports of the plurality of optical ports into one or more optical waves; configuring an optical interconnection structure between the input port and a first optical power splitting module of the plurality of optical power splitting modules such that the input port and the first optical power splitting module are in optical communication; and configuring optical interconnection structures between the plurality of optical amplification modules, the plurality of optical power splitting modules, and the plurality of optical ports such that each optical power splitting module is configured to provide portions of an optical wave to at least one of (1) an optical port of the plurality of optical ports along a path comprising one or more optical amplification modules of the plurality of optical amplification modules, or (2) a different optical power splitting module of the plurality of optical power splitting modules along a path comprising one or more optical amplification modules of the plurality of optical amplification modules.

In another aspect, in general, an apparatus comprises: an input port configured to receive an optical wave; a plurality of optical amplification modules, each configured to apply a gain to an optical wave propagating through that optical amplification module; a plurality of optical power splitting modules, each configured to provide portions of an input optical wave to each output of two or more outputs according to an optical power splitting ratio associated with that optical power splitting module; and a plurality of optical ports, where each optical port is configured to provide an optical wave; wherein a first optical power splitting module of the plurality of optical power splitting modules is in optical communication with the input port; wherein each optical power splitting module is configured to provide portions of an optical wave to at least one of (1) an optical port of the plurality of optical ports along a path comprising one or more optical amplification modules of the plurality of optical amplification modules, or (2) a different optical power splitting module of the plurality of optical power splitting modules along a path comprising one or more optical amplification modules of the plurality of optical amplification modules; and wherein at least a first optical amplification module that receives an optical wave over a first path from the input port through one or more optical power splitting modules is configured to apply a gain that is less than twice an inverse of an optical power splitting ratio associated with an optical power splitting module that is either (1) upstream and closer to the first optical amplification module than all other optical power splitting modules upstream on the first path or (2) downstream and closer to the first optical amplification module than all other optical power splitting modules downstream on the first path.

Aspects can include one or more of the following features.

The apparatus further comprises a plurality of phase modulation modules, where each phase modulation module of the plurality of phase modulation modules is configured to apply a phase modulation to an optical wave propagating through that phase modulation module of the plurality of phase modulation modules, and where each phase modulation module is in optical communication with an optical amplification module of the plurality of optical amplification modules or an optical power splitting module of the plurality of optical power splitting modules.

Each phase modulation module of the plurality of phase modulation modules is in optical communication with an optical port of the plurality of optical ports.

Each phase modulation module of the plurality of phase modulation modules is configured to apply the phase modulation in response to a control signal provided to that phase modulation module of the plurality of phase modulation modules.

One or more optical amplification modules of the plurality of optical amplification modules are further configured to apply a phase modulation to an optical wave propagating through that optical amplification module of the one or more optical amplification modules.

The plurality of optical power splitting modules is interconnected in a tree network, with each different path of a plurality of paths through the tree network including one or more optical amplification modules.

Each portion of a path through the tree network between two different optical power splitting modules includes at least one optical amplification module.

The first optical power splitting module of the plurality of optical power splitting modules is in optical communication with the input port along a path that includes an optical amplification module of the plurality of optical amplification modules.

Each optical amplification module of the plurality of optical amplification modules is configured to apply the gain to the optical wave in response to a control signal provided to that optical amplification module of the plurality of optical amplification modules.

The apparatus further comprises circuitry configured to provide a control signal to each optical amplification module of the plurality of optical amplification modules.

At least one control signal is generated based at least in part on a measurement of at least a portion of an optical wave provided to an optical port of the plurality of optical ports.

The gain that each optical amplification module of the plurality of optical amplification modules applies to an optical wave is based at least in part on an optical power splitting ratio associated with an optical power splitting module of the plurality of optical power splitting modules that provides an optical wave to that optical amplification module of the plurality of optical amplification modules.

At least one path along which an optical power splitting module of the plurality of optical power splitting modules provides an optical wave has an optical path length that is different from an optical path length of a path along which a different optical power splitting module of the plurality of optical power splitting modules provides an optical wave.

The apparatus further comprises one or more filtering modules, where each filtering module of the one or more filtering modules is configured to separate optical waves propagating through that filtering module of the one or more filtering modules, and where each filtering module of the one or more filtering modules is in optical communication with an optical amplification module of the plurality of optical amplification modules or an optical power splitting module of the plurality of optical power splitting modules.

The apparatus further comprises an optical combining arrangement configured to combine at least a portion of an optical wave from each optical port of two or more optical ports of the plurality of optical ports into one or more optical waves.

Each optical port of the two or more optical ports associated with the optical combining arrangement is in optical communication with an optical reflector such that the optical combining arrangement uses one or more optical power splitting modules of the plurality of optical power splitting modules to combine optical waves.

The optical combining arrangement comprises a free-space optical combining arrangement configured to combine at least a portion of an optical wave from each optical port of the plurality of optical ports into a spatial mode of an optical wave.

The optical combining arrangement comprises a network of a plurality of optical combining modules, where each optical combining module of the plurality of optical combining modules is configured to receive at least two optical waves and combine the at least two optical waves into an optical wave.

In another aspect, in general, a method comprises: arranging an input port configured to receive an optical wave; arranging a plurality of optical amplification modules, each configured to apply a gain to an optical wave propagating through that optical amplification module; arranging a plurality of optical power splitting modules, each configured to provide portions of an input optical wave to each output of two or more outputs according to an optical power splitting ratio associated with that optical power splitting module; arranging a plurality of optical ports, each configured to provide an optical wave; configuring an optical interconnection structure between the input port and a first optical power splitting module of the plurality of optical power splitting modules such that the input port and the first optical power splitting module are in optical communication; and configuring optical interconnection structures between the plurality of optical power splitting modules, the plurality of optical amplification modules, and the plurality of optical ports such that each optical power splitting module is configured to provide portions of an optical wave to at least one of (1) an optical port of the plurality of optical ports along a path comprising one or more optical amplification modules of the plurality of optical amplification modules, or (2) a different optical power splitting module of the plurality of optical power splitting modules along a path comprising one or more optical amplification modules of the plurality of optical amplification modules; wherein at least a first optical amplification module that receives an optical wave over a first path from the input port through one or more optical power splitting modules is configured to apply a gain that is less than twice an inverse of an optical power splitting ratio associated with an optical power splitting module that is upstream and closer to the first optical amplification module than all other optical power splitting modules upstream on the first path or downstream and closer to the first optical amplification module than all other optical power splitting modules downstream on the first path.

In another aspect, in general, an apparatus comprises: an input port configured to receive an optical wave; a plurality of optical amplification modules, each configured to apply a gain to an optical wave propagating through that optical amplification module; a plurality of optical power splitting modules, each configured to provide portions of an input optical wave to each output of two or more outputs according to an optical power splitting ratio associated with that optical power splitting module; and a plurality of optical ports, each configured to provide an optical wave; wherein the plurality of optical power splitting modules is interconnected in a tree network that comprises: a root stage of the tree network comprising a path segment between the input port and an input of a first optical power splitting module of the plurality of optical power splitting modules, a final stage of the tree network comprising a plurality of path segments between a respective output of an optical power splitting module and a respective optical port of the plurality of optical ports, and a plurality of inner stages of the tree network, each inner stage comprising a plurality of path segments between a respective output of an upstream optical power splitting module and a respective input of a downstream optical power splitting module; and wherein at least two inner stages each include a respective optical amplification module on one or more path segments of the plurality of path segments of that inner stage.

Aspects can include one or more of the following features.

The apparatus further comprises a plurality of phase modulation modules, where each phase modulation module of the plurality of phase modulation modules is configured to apply a phase modulation to an optical wave propagating through that phase modulation module of the plurality of phase modulation modules, and where each phase modulation module is in optical communication with an optical amplification module of the plurality of optical amplification modules or an optical power splitting module of the plurality of optical power splitting modules.

Each phase modulation module of the plurality of phase modulation modules is in optical communication with an optical port of the plurality of optical ports.

Each phase modulation module of the plurality of phase modulation modules is configured to apply the phase modulation in response to a control signal provided to that phase modulation module of the plurality of phase modulation modules.

One or more optical amplification modules of the plurality of optical amplification modules are further configured to apply a phase modulation to an optical wave propagating through that optical amplification module of the one or more optical amplification modules.

An optical amplification module is arranged on the path segment of the root stage of the tree network.

Each optical amplification module of the plurality of optical amplification modules is configured to apply the gain to the optical wave in response to a control signal provided to that optical amplification module of the plurality of optical amplification modules.

The apparatus further comprises circuitry configured to provide a control signal to each optical amplification module of the plurality of optical amplification modules.

At least one control signal is generated based at least in part on a measurement of at least a portion of an optical wave provided to an optical port of the plurality of optical ports.

The gain that each optical amplification module of the plurality of optical amplification modules applies to an optical wave is based at least in part on an optical power splitting ratio associated with an optical power splitting module of the plurality of optical power splitting modules that provides an optical wave to that optical amplification module of the plurality of optical amplification modules.

At least one path segment along which an optical power splitting module of the plurality of optical power splitting modules provides an optical wave has an optical path length that is different from an optical path length of a path segment along which a different optical power splitting module of the plurality of optical power splitting modules provides an optical wave.

The apparatus further comprises one or more filtering modules, where each filtering module of the one or more filtering modules is configured to separate optical waves propagating through that filtering module of the one or more filtering modules, and where each filtering module of the one or more filtering modules is in optical communication with an optical amplification module of the plurality of optical amplification modules or an optical power splitting module of the plurality of optical power splitting modules.

The apparatus further comprises an optical combining arrangement configured to combine at least a portion of an optical wave from each optical port of two or more optical ports of the plurality of optical ports into one or more optical waves.

Each optical port of the two or more optical ports associated with the optical combining arrangement is in optical communication with an optical reflector such that the optical combining arrangement uses one or more optical power splitting modules of the plurality of optical power splitting modules to combine optical waves.

The optical combining arrangement comprises a free-space optical combining arrangement configured to combine at least a portion of an optical wave from each optical port of the plurality of optical ports into a spatial mode of an optical wave.

The optical combining arrangement comprises a network of a plurality of optical combining modules, where each optical combining module of the plurality of optical combining modules is configured to receive at least two optical waves and combine the at least two optical waves into an optical wave.

Either (1) a first optical power of an optical wave propagating along a first path segment between a first optical power splitting module and a second optical power splitting module, and before an initial optical amplification module on the first path segment, is within a factor of two of a second optical power of an optical wave propagating along a second path segment between the second optical power splitting module and an initial optical amplification module on the second path segment or (2) a first optical power of an optical wave propagating along a first path segment between a first optical power splitting module and a second optical power splitting module, and after an initial optical amplification module on the first path segment, is within a factor of two of a second optical power of an optical wave propagating along a second path segment between the second optical power splitting module and an initial optical amplification module on the second path segment.

At least a first optical amplification module that receives an optical wave over a first path from the input port through one or more optical power splitting modules is configured to apply a gain that is less than twice an inverse of an optical power splitting ratio associated with an optical power splitting module that is either (1) upstream and closer to the first optical amplification module than all other optical power splitting modules upstream on the first path or (2) downstream and closer to the first optical amplification module than all other optical power splitting modules downstream on the first path.

In another aspect, in general, a method comprises: arranging an input port configured to receive an optical wave; arranging a plurality of optical amplification modules, each configured to apply a gain to an optical wave propagating through that optical amplification module; arranging a plurality of optical power splitting modules, each configured to provide portions of an input optical wave to each output of two or more outputs according to an optical power splitting ratio associated with that optical power splitting module; arranging a plurality of optical ports, each configured to provide an optical wave; and configuring a tree network to interconnect the plurality of optical power splitting modules, the tree network comprising: a root stage of the tree network comprising a path segment between the input port and an input of a first optical power splitting module of the plurality of optical power splitting modules, a final stage of the tree network comprising a plurality of path segments between a respective output of an optical power splitting module and a respective optical port of the plurality of optical ports, and a plurality of inner stages of the tree network, each inner stage comprising a plurality of path segments between a respective output of an upstream optical power splitting module and a respective input of a downstream optical power splitting module; wherein at least two inner stages each include a respective optical amplification module on one or more path segments of the plurality of path segments of that inner stage.

In another aspect, in general, an apparatus comprises: an input port configured to receive an optical wave; a plurality of optical amplification modules, each configured to apply a gain to an optical wave propagating through that optical amplification module; a plurality of optical power splitting modules, each configured to provide portions of an input optical wave to each output of two or more outputs according to an optical power splitting ratio associated with that optical power splitting module; and a plurality of optical ports, each configured to provide an optical wave; wherein the plurality of optical power splitting modules is interconnected in a tree network that comprises: a root stage of the tree network comprising a path segment between the input port and an input of a first optical power splitting module of the plurality of optical power splitting modules, a final stage of the tree network comprising a plurality of path segments between a respective output of an optical power splitting module and a respective optical port of the plurality of optical ports, and one or more inner stages of the tree network, each inner stage comprising a plurality of path segments between a respective output of an upstream optical power splitting module and a respective input of a downstream optical power splitting module; and wherein either (1) a first optical power of an optical wave propagating along a first path segment between a first optical power splitting module and a second optical power splitting module, and before an initial optical amplification module on the first path segment, is within a factor of two of a second optical power of an optical wave propagating along a second path segment between the second optical power splitting module and an initial optical amplification module on the second path segment or (2) a first optical power of an optical wave propagating along a first path segment between a first optical power splitting module and a second optical power splitting module, and after an initial optical amplification module on the first path segment, is within a factor of two of a second optical power of an optical wave propagating along a second path segment between the second optical power splitting module and an initial optical amplification module on the second path segment.

Aspects can include one or more of the following features.

The apparatus further comprises a plurality of phase modulation modules, where each phase modulation module of the plurality of phase modulation modules is configured to apply a phase modulation to an optical wave propagating through that phase modulation module of the plurality of phase modulation modules, and where each phase modulation module is in optical communication with an optical amplification module of the plurality of optical amplification modules or an optical power splitting module of the plurality of optical power splitting modules.

Each phase modulation module of the plurality of phase modulation modules is in optical communication with an optical port of the plurality of optical ports.

Each phase modulation module of the plurality of phase modulation modules is configured to apply the phase modulation in response to a control signal provided to that phase modulation module of the plurality of phase modulation modules.

One or more optical amplification modules of the plurality of optical amplification modules are further configured to apply a phase modulation to an optical wave propagating through that optical amplification module of the one or more optical amplification modules.

An optical amplification module is arranged on the path segment of the root stage of the tree network.

Each optical amplification module of the plurality of optical amplification modules is configured to apply the gain to the optical wave in response to a control signal provided to that optical amplification module of the plurality of optical amplification modules.

The apparatus further comprises circuitry configured to provide a control signal to each optical amplification module of the plurality of optical amplification modules.

At least one control signal is generated based at least in part on a measurement of at least a portion of an optical wave provided to an optical port of the plurality of optical ports.

The gain that each optical amplification module of the plurality of optical amplification modules applies to an optical wave is based at least in part on an optical power splitting ratio associated with an optical power splitting module of the plurality of optical power splitting modules that provides an optical wave to that optical amplification module of the plurality of optical amplification modules.

At least one path segment along which an optical power splitting module of the plurality of optical power splitting modules provides an optical wave has an optical path length that is different from an optical path length of a path segment along which a different optical power splitting module of the plurality of optical power splitting modules provides an optical wave.

The apparatus further comprises one or more filtering modules, where each filtering module of the one or more filtering modules is configured to separate optical waves propagating through that filtering module of the one or more filtering modules, and where each filtering module of the one or more filtering modules is in optical communication with an optical amplification module of the plurality of optical amplification modules or an optical power splitting module of the plurality of optical power splitting modules.

The apparatus further comprises an optical combining arrangement configured to combine at least a portion of an optical wave from each optical port of two or more optical ports of the plurality of optical ports into one or more optical waves.

Each optical port of the two or more optical ports associated with the optical combining arrangement is in optical communication with an optical reflector such that the optical combining arrangement uses one or more optical power splitting modules of the plurality of optical power splitting modules to combine optical waves.

The optical combining arrangement comprises a free-space optical combining arrangement configured to combine at least a portion of an optical wave from each optical port of the plurality of optical ports into a spatial mode of an optical wave.

The optical combining arrangement comprises a network of a plurality of optical combining modules, where each optical combining module of the plurality of optical combining modules is configured to receive at least two optical waves and combine the at least two optical waves into an optical wave.

At least a first optical amplification module that receives an optical wave over a first path from the input port through one or more optical power splitting modules is configured to apply a gain that is less than twice an inverse of an optical power splitting ratio associated with an optical power splitting module that is either (1) upstream and closer to the first optical amplification module than all other optical power splitting modules upstream on the first path or (2) downstream and closer to the first optical amplification module than all other optical power splitting modules downstream on the first path.

In another aspect, in general, a method comprises: arranging an input port configured to receive an optical wave; arranging a plurality of optical amplification modules, each configured to apply a gain to an optical wave propagating through that optical amplification module; arranging a plurality of optical power splitting modules, each configured to provide portions of an input optical wave to each output of two or more outputs according to an optical power splitting ratio associated with that optical power splitting module; arranging a plurality of optical ports, each is configured to provide an optical wave; and configuring a tree network interconnecting the plurality of optical power splitting modules, the tree network comprising: a root stage of the tree network comprising a path segment between the input port and an input of a first optical power splitting module of the plurality of optical power splitting modules, a final stage of the tree network comprising a plurality of path segments between a respective output of an optical power splitting module and a respective optical port of the plurality of optical ports, and one or more inner stages of the tree network, each inner stage comprising a plurality of path segments between a respective output of an upstream optical power splitting module and a respective input of a downstream optical power splitting module; wherein either (1) a first optical power of an optical wave propagating along a first path segment between a first optical power splitting module and a second optical power splitting module, and before an initial optical amplification module on the first path segment, is within a factor of two of a second optical power of an optical wave propagating along a second path segment between the second optical power splitting module and an initial optical amplification module on the second path segment or (2) a first optical power of an optical wave propagating along a first path segment between a first optical power splitting module and a second optical power splitting module, and after an initial optical amplification module on the first path segment, is within a factor of two of a second optical power of an optical wave propagating along a second path segment between the second optical power splitting module and an initial optical amplification module on the second path segment.

Aspects can have one or more of the following advantages.

Using the methods and techniques disclosed herein, an optical amplifier can be configured according to a circuit architecture comprising a plurality of optical amplification modules arranged in a tree structure. Such implementations can allow for optical amplifiers with high gain, high output power, and high efficiency to be configured. The number of stages in the tree of the optical amplifier may be increased to achieve more gain and output power at the cost of additional optical amplification modules of the optical amplifier. In some examples, these optical amplification modules can comprise semiconductor optical amplifiers that can improve the overall efficiency of the optical amplifier, reduce the overall size of the amplifier, and improve the compatibility of the amplifier in a larger integrated photonic circuit. For instance, an amplifier comprising optical amplification modules can be fabricated using fabrication techniques that are compatible with other integrated circuit fabrication techniques, such as epitaxy.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. The plots resulting from numerical simulations, as indicated below, are working examples of experimental results associated with some of the techniques described herein, and the other plots are prophetic examples of predicted experimental results.

FIGS. 1A-1I are schematic diagrams of example circuit architectures.

FIGS. 2A-2E are plots of numerical simulations associated with configuring circuit architectures.

FIGS. 3A-3B are schematic diagrams of example optical combining arrangements.

FIGS. 4A-4N are schematic diagrams of example circuit architectures.

FIGS. 5A-5C are schematic diagrams of example devices comprising circuit architectures.

FIG. 6 is a schematic diagram of an example waveguide.

FIGS. 7A-7D are schematic diagrams of example circuit architectures in optical cavities.

### DETAILED DESCRIPTION

Designing and implementing optical amplifiers can balance operating characteristics including gain, gain saturation, and efficiency. In some examples, a gain of an optical amplifier can be associated with an amplification factor that a medium of the optical amplifier is configured to apply to an optical wave. In other words, a gain can be associated with an amount of output power produced by the optical amplifier relative to an amount of input power to the optical amplifier. In some examples, gain saturation of an optical amplifier can refer to an effect wherein the gain that a medium can apply to an optical wave is reduced at high input powers. The point at which a gain of an optical amplifier decays by 3 dB from the small-signal gain can be referred to as a saturation output power of the optical amplifier and can be proportional to the maximum output power of the optical amplifier. In some examples, an efficiency of an optical amplifier can be associated with the optical power produced by the optical amplifier as a function of the electrical power consumed by the optical amplifier. Achieving high gain, high saturation output power, and high efficiency of an optical amplifier can be challenging as designs that increase one or more of these operating characteristics can result in decreases of other operating characteristics. In other words, optical amplifier design can be associated with trade-offs between efficiency, gain, and saturation output power.

In some implementations, an optical amplifier can be configured such that the optical amplifier simultaneously achieves high gain, high saturation output power, and high efficiency. Using the methods disclosed herein, an optical amplifier can be configured in a tree-like structure in which light is iteratively split using multiple stages of optical power splitting modules and amplified using multiple stages of sub-amplifiers or optical amplification modules. In some examples, light can then be recombined back into a single waveguide, or can be directed to other optical components, such as an optical phased array. By splitting and amplifying light in multiple stages, optical amplification modules having modest gain and saturation output power can be used in each stage, without impacting the overall performance of the optical amplifier. Further, splitting the amplification into multiple discrete amplifier elements can help to improve thermal management, as the discrete amplifier elements can be distributed throughout a circuit architecture to improve heat dissipation and to reduce thermal crosstalk among elements. Each amplifier element may be operated close to saturation, increasing the efficiency of the device. The number of splitting stages may be arbitrarily increased to increase the total gain and total output power of the staged amplifier.

In some implementations, an integrated circuit architecture can be formed as part of a system. A system can be implemented in various configurations, including as a single apparatus or as a combination of one or more apparatuses that collectively perform the functions of a system. In some examples, the one or more apparatuses can form a device, i.e., a system-on-a-chip, or the one or more apparatuses can be separate devices.

In some implementations, a system can be formed from one or more integrated circuit (IC) chips comprising portions of a circuit architecture. Some circuit architectures can be distributed across multiple chips or consolidated onto a single chip. Some chips can comprise multiple layers of material. In some examples, portions of a circuit architecture can be formed across several layers of devices.

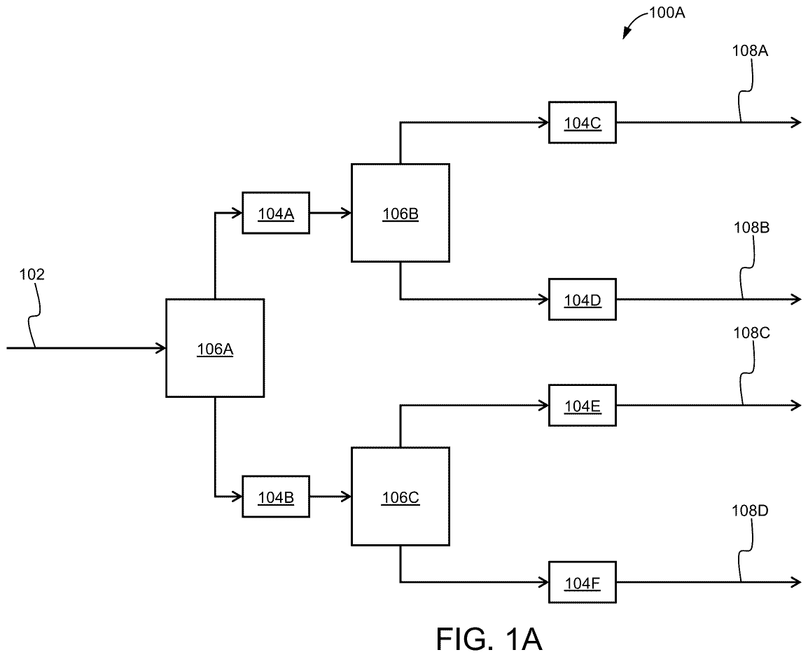

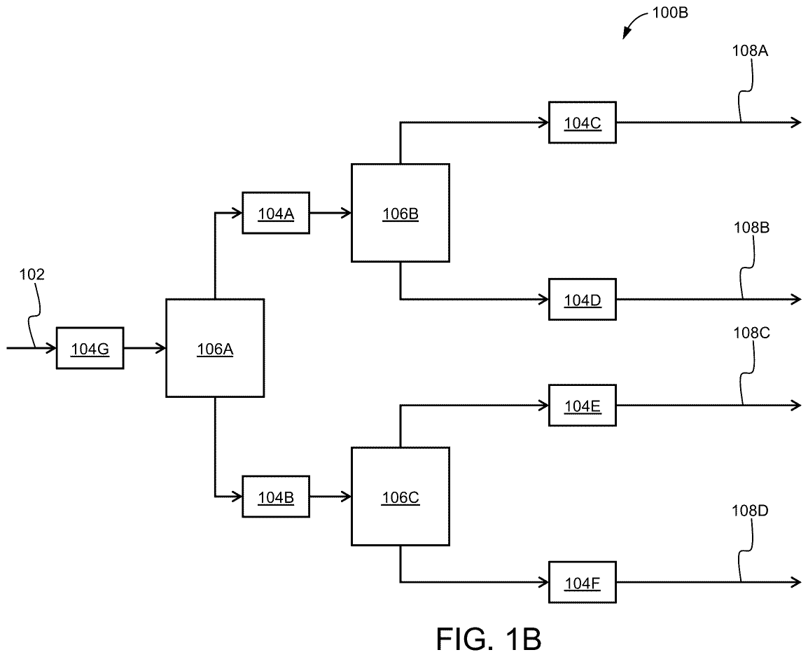

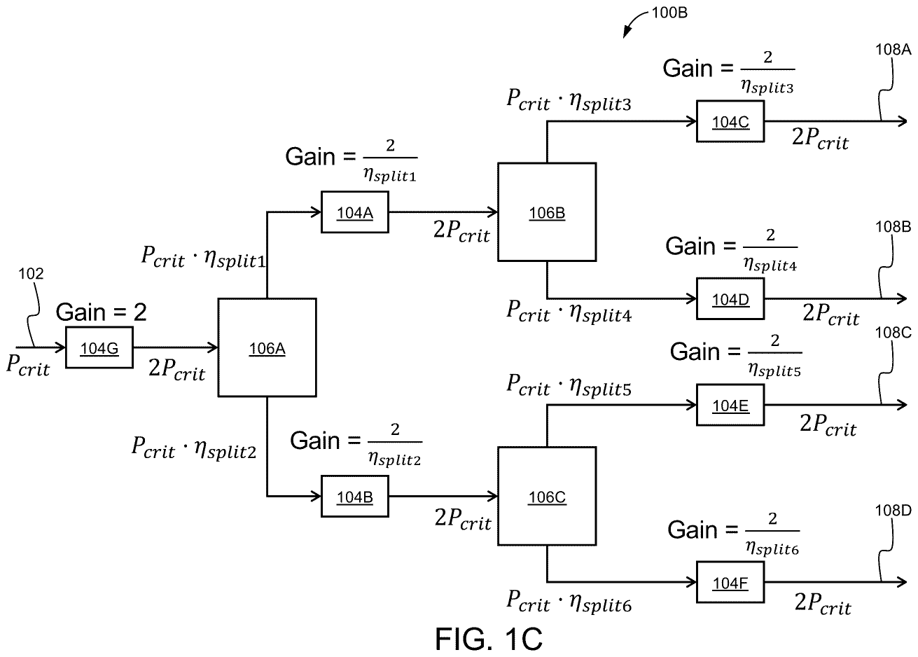

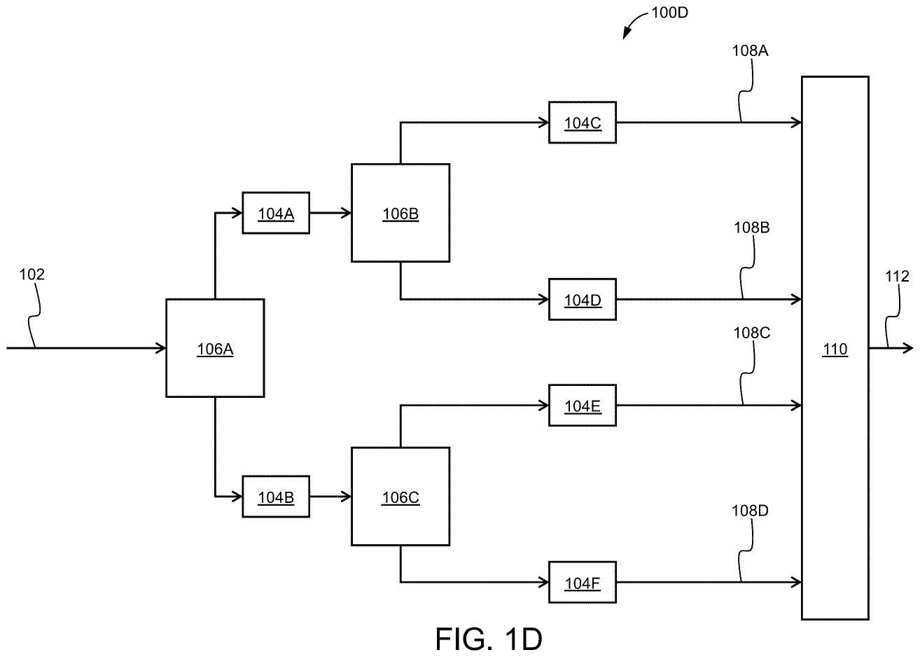

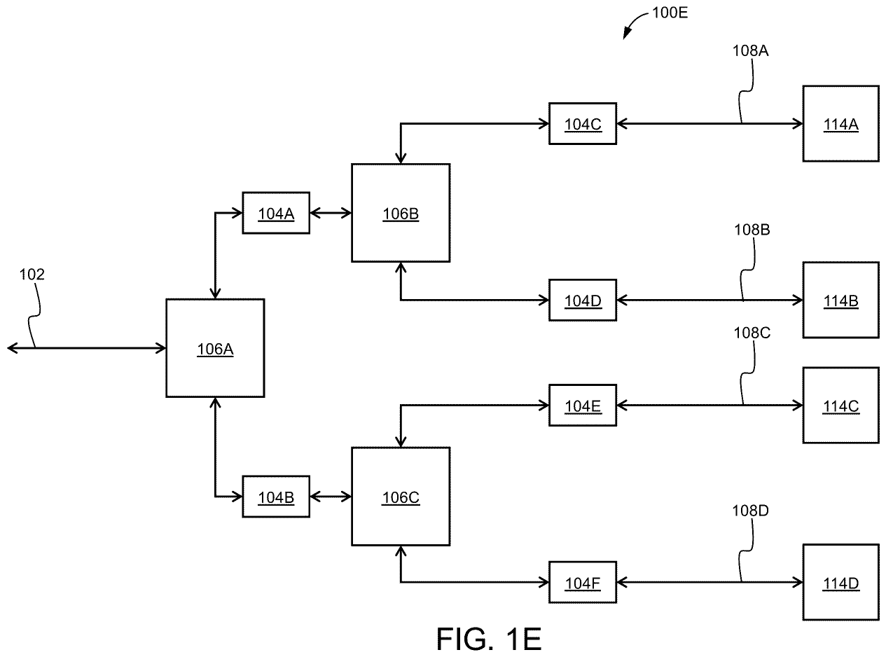

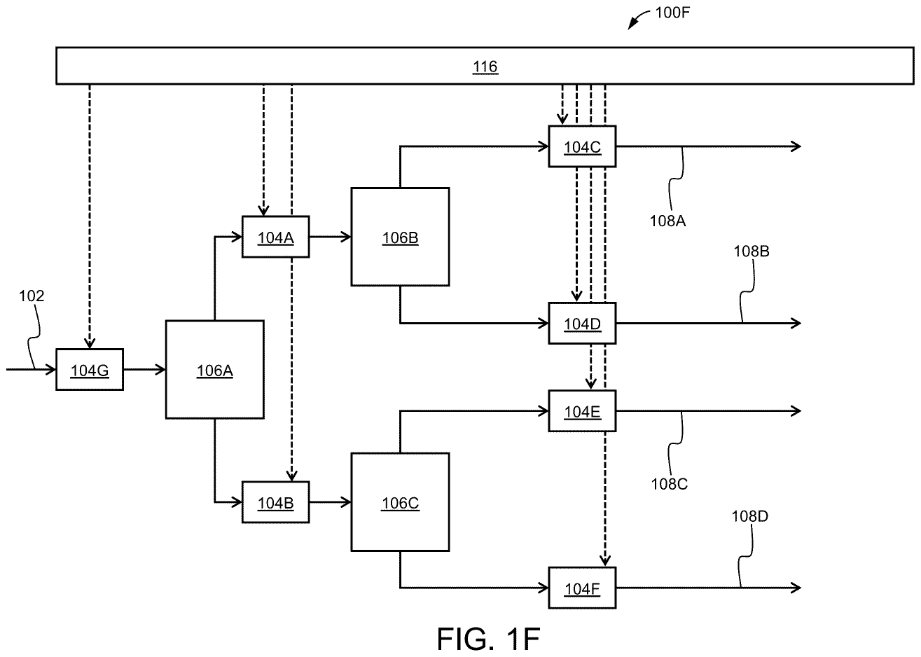

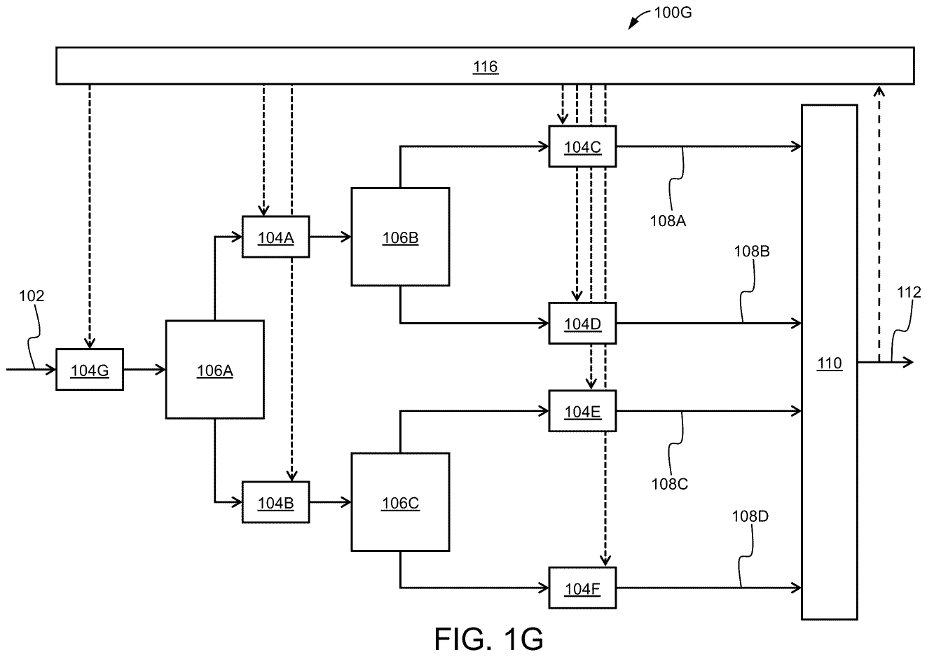

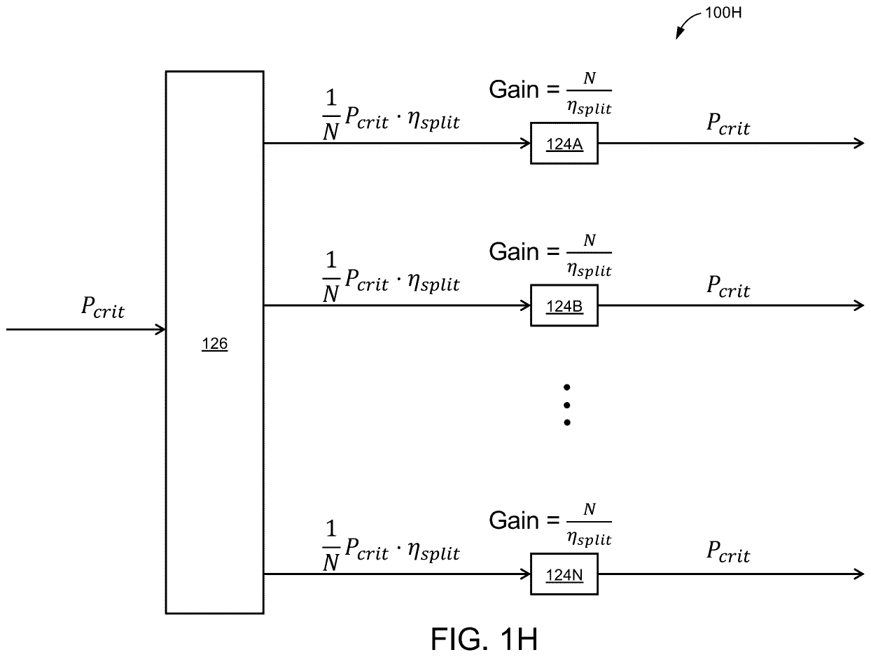

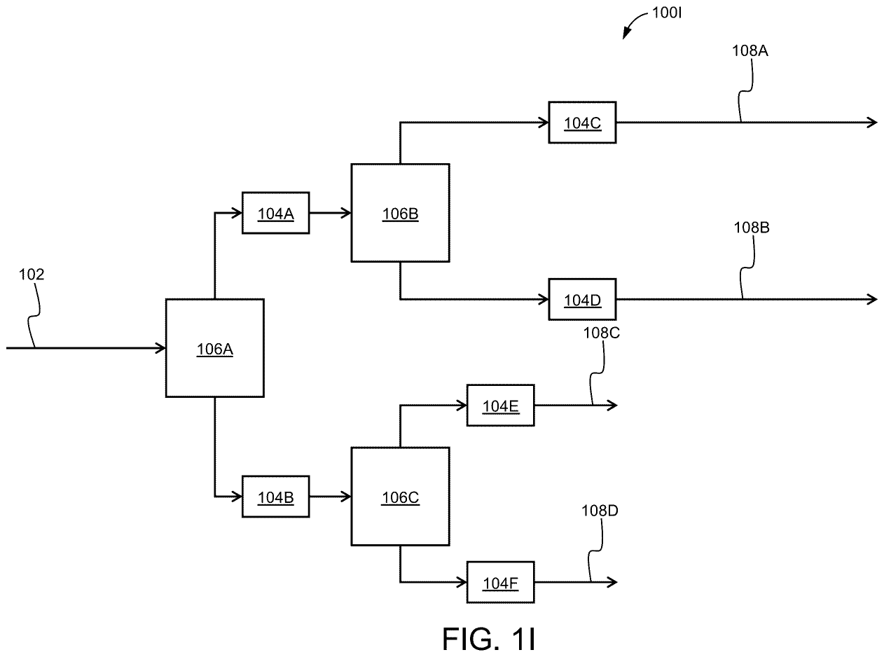

FIG. 1A depicts an example circuit architecture 100A configured as an optical amplifier. The circuit architecture 100A comprises an input port 102. In some implementations, the input port 102 can be an optical port formed from a portion of an optical waveguide. The circuit architecture 100A further comprises a plurality of optical amplification modules 104A-104F, i.e., an optical amplification module 104A, an optical amplification module 104B, an optical amplification module 104C, an optical amplification module 104D, an optical amplification module 104E, and an optical amplification module 104F. Each optical amplification module of the plurality of optical amplification modules 104A-104F is configured to apply a gain to an optical wave propagating through that optical amplification module. The circuit architecture 100A further comprises a plurality of optical power splitting modules 106A-106C, i.e., an optical power splitting module 106A, an optical power splitting module 106B, and an optical power splitting module 106C. Each optical power splitting module of the plurality of optical power splitting modules 106A-106C is configured to provide portions of an input optical wave to each output of two or more outputs according to an optical power splitting ratio associated with that optical power splitting module. The circuit architecture 100A further comprises a plurality of optical ports 108A-108D, i.e., an optical port 108A, an optical port 108B, an optical port 108C, and an optical port 108D. Each optical port of the plurality of optical ports 108A-108D is configured to provide an optical wave. In some examples, each optical port of the plurality of optical ports 108A-108D can be a portion of an optical waveguide. As shown in FIG. 1A, each optical power splitting module of the plurality of optical power splitting modules 106A-106C is configured to provide portions of an optical wave to at least one of (1) an optical port of the plurality of optical ports 108A-108D along a path comprising one or more optical amplification modules of the plurality of optical amplification modules 104A-104F, or (2) a different optical power splitting module of the plurality of optical power splitting modules 106A-106C along a path comprising one or more optical amplification modules of the plurality of optical amplification modules 104A-104F.

In some implementations, optical waves can be provided to optical ports or optical amplification modules along paths or path segments that include other optical components. For instance, optical waves can be provided along paths that include optical components such as optical filters or phase modulation modules. Examples are described and depicted later.

In some examples, the input port 102, the plurality of optical amplification modules 104A-104F, the plurality of optical power splitting modules 106A-106C, and the plurality of optical ports 108A-108D can be in optical communication with each other via optical waveguides or optical waveguiding structures. In other words, the input port 102, the plurality of optical amplification modules 104A-104F, the plurality of optical power splitting modules 106A-106C, and the plurality of optical ports 108A-108D can be interconnected by optical waveguides or optical waveguiding structures. Such configurations can also be referred to as optical interconnection structures.

In other words, the circuit architecture 100A comprises a plurality of optical amplification modules 104A-104F that are interconnected in a tree structure. In this tree structure, the output of each optical amplification module of the plurality of optical amplification modules 104A-104F is connected to a splitting element, which distributes the power from that optical amplification module of the plurality of optical amplification modules 104A-104F into two or more output waveguides. The two or more output waveguides are in turn connected to another optical amplification module of the plurality of optical amplification modules 104A-104F. At each stage of the tree, each optical amplification module of the plurality of optical amplification modules 104A-104F provide gain to the optical mode in their respective waveguide before splitting the power into a number of output waveguides and repeating the process.

In some examples, the circuit architecture 100A can be referred to as having a tree network configuration. As shown in FIG. 1A, the tree network comprises a root stage of the tree network comprising a path segment between the input port 102 and an input of the optical power splitting module 106A. The tree network further comprises a final stage of the tree network comprising a plurality of path segments between a respective output of an optical power splitting module of the plurality of optical power splitting modules 106A-106C and a respective optical port of the plurality of optical ports 108A-108D. By way of example, the final stage comprises a path segment between the optical power splitting module 106B and the optical port 108A, and a path segment between the optical power splitting module 106B and the optical port 108B. The tree network further comprises a plurality of inner stages of the tree network, where each inner stage of the plurality of inner stages comprises a plurality of path segments between a respective output of an upstream optical power splitting module of the plurality of optical power splitting modules 106A-106C and a respective input of a downstream optical power splitting module of the plurality of optical power splitting modules 106A-106C. At least two inner stages of the plurality of inner stages include a respective optical amplification module of the plurality of optical amplification modules 104A-104F on one or more of the path segments of the plurality of the path segments of that inner stage. By way of example, the tree network shown in FIG. 1A comprises an inner segment between the output of the optical power splitting module 106A and the input of the optical power splitting module 106B, where the inner segment comprises the optical amplification module 104A. The tree network shown in FIG. 1A further comprises an inner segment between the output of the optical power splitting module 106A and the input of the optical power splitting module 106C, where the inner segment comprises the optical amplification module 104B.

In addition, each portion of a path through the tree between two different optical power splitting modules of the plurality of optical power splitting modules 106A-106C includes at least one optical amplification module of the plurality of optical amplification modules 104A-104F.

In this example, each optical power splitting module of the plurality of optical power splitting modules 106A-106C are configured as 1×2 power splitters. Other arrangements, e.g., 1×3, 1×4, 2×2, or 2×3, and mixtures of arrangements may also be utilized. Some optical power splitting modules can be configured to split optical power among two or more outputs of the optical power splitting module according to an optical power splitting ratio. For instance, a 1×2 power splitter can be configured to split 50% of optical power into one output and 50% of optical power into the other output. This configuration can also be referred to as a 50/50 power splitter. Other combinations can also be used, i.e., 50/50, 33/67, 25/75.

Other combinations of outputs and optical power distributions can be used. By way of example, a 1×3 optical power splitting module can be configured to distribute optical power to the three outputs according to a 50/25/25 optical power splitting ratio.

In some implementations, an optical power splitting module can comprise one or more optical power splitters. By way of example, an optical power splitting module configured as a 1×4 power splitter can comprise a 1×2 power splitter followed by two 1×2 power splitters. In some examples, an optical power splitting module comprising multiple power splitters can also comprise modules such as optical filters or phase modulation components in between the power splitters.

In other words, in some implementations, different stages in the SOA amplification tree split the light into different numbers of waveguides than other stages in the amplification tree. For instance, the first stage of an amplifier may split the input into more than two waveguides whereas later stages can split the output of each SOA into just two outputs. In some implementations, splitters within the same stage of the SOA amplification tree can split light into different numbers of waveguides than other splitters in the same stage of the amplification tree.

FIG. 1B depicts an example circuit architecture 100B comprising a similar configuration to the circuit architecture 100A. In this example, the circuit architecture 100B further comprises an optical amplification module 104G such that the circuit architecture 100B comprises a plurality of optical amplification modules 104A-104G. The optical amplification module 104G is in optical communication with the input port 102 and the optical power splitting module 106A.

In some implementations, each optical amplification module of the plurality of optical amplification modules can comprise a respective Semiconductor Optical Amplifier (SOA) integrated in an optical waveguide. In some examples, SOAs can be considered as half of a laser in that an SOA can provide gain and confinement in 2 dimensions, but no feedback. Some SOAs can be designed to operate in a particular wavelength band.

When pumped strongly enough, circuit architectures configured in a tree network can self-limit such that the gain in each SOA can match the splitting ratio plus any insertion loss in the stage. This trend can be associated with power saturation effects in the amplifier, i.e., for any amplifier, gain can tend to roll off as input power to the amplifier increases. For identical SOAs configured in a tree structure, a critical power can be provided to the input of the SOA such that the gain in the SOA compensates for the combination of power reduction in each waveguide due to the splitting ratio and any device insertion losses.

By way of example, FIG. 1C depicts the example circuit architecture 100B labeled with optical powers associated with optical paths and optical gains associated with optical amplification modules of the plurality of optical amplification modules 104A-104G. The input port 102 is associated with an optical power P_{crit}. The optical amplification module 104G is configured to apply a gain of 2 such that the optical power after the optical amplification module 104G is 2P_{crit}. In this example, the optical power splitting module 106A is configured to split an optical wave into two outputs. To compensate for this optical power split, the optical amplification module 104G applies a gain of 2 to an optical wave. The optical power splitting module 106A is associated with an insertion loss ηₛₚₗᵢₜ such that the optical power following the optical power splitting module 106A is P_{crit}·ηₛₚₗᵢₜ₁ at one output and P_{crit}·ηₛₚₗᵢₜ₂ at the other output. The optical amplification module 104A is configured to apply a gain of

$$\frac{2}{{η}_{split 1}}$$

such that the optical power following the optical amplification module 104A is 2P_{crit}. The optical amplification module 104B is configured to apply a gain of

$$\frac{2}{{η}_{split 2}}$$

such that the optical power following the optical amplification module 104B is 2P_{crit}. The optical power splitting module 106B is associated with an insertion loss ηₛₚₗᵢₜ such that the optical power following the optical power splitting module 106B is P_{crit}·ηₛₚₗᵢₜ₃ at one output and P_{crit}·ηₛₚₗᵢₜ₄ at the other output. The optical amplification module 104C is configured to apply a gain of

$$\frac{2}{{η}_{split 3}}$$

such that the optical power following the optical amplification module 104C is 2P_{crit}. The optical amplification module 104D is configured to apply a gain of

$$\frac{2}{{η}_{split 4}}$$

such that the optical power following the optical amplification module 104D is 2P_{crit}. The optical power splitting module 106C is associated with an insertion loss ηₛₚₗᵢₜ such that the optical power following the optical power splitting module 106C is P_{crit}·ηₛₚₗᵢₜ₅ at one output and P_{crit}·ηₛₚₗᵢₜ₆ at the other output. The optical amplification module 104E is configured to apply a gain of

$$\frac{2}{{η}_{split 5}}$$

such that the optical power following the optical amplification module 104E is 2P_{crit}. The optical amplification module 104F is configured to apply a gain of

$$\frac{2}{{η}_{split 6}}$$

such that the optical power following the optical amplification module 104F is 2P_{crit}. As shown in FIG. 1C, the optical power in each optical port of the plurality of optical ports 108A-108D is 2P_{crit}. As described later, in some examples, an optical combiner can be used to combine optical ports of the plurality of optical ports 108A-108D. If an optical combiner having an efficiency η_{combiner} is used to combine the plurality of optical ports 108A-108D, the optical power after the optical combiner can be 8·η_{combiner}·P_{crit}.

In other words, as shown in FIG. 1C, a gain that each optical amplification module of the plurality of optical amplification modules 104A-104F applies to an optical wave is based at least in part on an optical power splitting ratio associated with an optical power splitting module of the plurality of optical power splitting modules 106A-106C that immediately precedes that optical amplification module of the plurality of optical amplification modules 104A-104F.

As shown in FIG. 1C, each optical power splitting module of the plurality of optical power splitting modules 106A-106C has one input and two outputs and is configured to split the optical power according to a power splitting ratio of 50/50. Each optical amplification module of the plurality of optical amplification modules 104A-104F is configured to compensate for this power splitting ratio by applying a gain of 2 divided by the insertion loss of the optical power splitting module to an optical wave. Some optical splitting modules can be configured to provide portions of an optical wave to n outputs, where n is an integer. Such optical splitting modules can have a splitting ratio of 1/n. These portions of optical waves can be provided to optical amplification modules that can apply a gain of n to the portions of the optical wave. In other words, the optical amplification modules are configured to apply a gain that is less than twice the inverse of an optical power splitting module. An example of this configuration is depicted later in FIG. 1H.

While the configuration shown in FIG. 1C has optical amplification modules of the plurality of optical amplification modules that are configured to apply a gain based on the optical power splitting module that provides an optical wave to the optical amplification modules, i.e., an upstream optical power splitting module, some configurations can be reversed. In other words, an optical amplification module can be configured to apply a gain based on a downstream optical power splitting module, i.e., an optical power splitting module that receives an optical wave from the optical amplification module.

In other words, as shown in FIG. 1C, an optical amplification module, i.e., the optical amplification module 104A, that receives an optical wave over a first path from the input port through one or more optical power splitting modules is configured to apply a gain that is less than twice an inverse of an optical power splitting ratio associated with an optical power splitting module, i.e., the optical power splitting module 106A, that is upstream and closer to the optical amplification module than all other optical power splitting modules upstream on the first path. Alternatively, an optical amplification module that receives an optical wave over a first path from the input port through one or more optical power splitting modules can be configured to apply a gain that is less than twice an inverse of an optical power splitting ratio associated with an optical power splitting module that is downstream and closer to the optical amplification module than all other optical power splitting modules downstream on the first path.

As shown in FIG. 1C, a first optical power of an optical wave propagating along a first path segment between a first optical power splitting module of the plurality of optical power splitting modules 106A-106C and a second optical power splitting module of the plurality of optical power splitting modules 106A-106C, and before an initial optical amplification module of the plurality of optical amplification modules 104A-104G, is within a factor of two of a second optical power of an optical wave propagating in a second path segment between the second optical power splitting module of the plurality of optical power splitting modules 106A-106C and an initial optical amplification module of the plurality of optical amplification modules 104A-104G on the second path segment. By way of example, an optical wave propagating between the optical power splitting module 106A and the optical amplification module 104A has an optical power within a factor of two of an optical wave propagating between the optical power splitting module 106B and the optical amplification module 104C.

In some implementations, SOAs within the amplification tree can be pumped with the intent of achieving different gains or saturation powers than other SOAs within the tree.

In some implementations, configuring an optical amplifier having a tree-like architecture of optical amplification modules, i.e., SOAs, can decouple some aspects of the overall specifications of the aggregate optical amplifier from the specifications of the individual SOAs used as elements. For instance, an optical amplifier configured to produce 30 dB of gain with a total output power of 1 W can be achieved using a circuit architecture comprising 10 stages of optical gain, where each stage provides 3 dB of gain and each amplification module has a saturation output power of approximately 1 mW. Alternatively, a device configured to produce 30 dB of gain with a total output power of 1 W can be achieved using a circuit architecture comprising 5 stages of optical gain, where each stage provides 6 dB of gain and each amplification module has a saturation output power of approximately 30 mW. This decoupling of aggregate amplification characteristics from the amplification characteristics of amplification modules in a device allows choices to be made for the element design that would not be made for high-power, high-gain amplifiers. For instance, an optical amplification module can comprise an SOA with high-confinement single mode waveguides having a small mode area and high confinement factor. Such SOAs can amplify light over shorter distances and use less power than devices with large mode areas and low confinement factors.

In other words, configuring an optical amplification module using the methods disclosed herein can allow for low-power operation of optical components. For instance, an optical power propagating through optical components can be substantially less than or equal to 75 mW. In some examples, an optical power propagating through optical components can be substantially less than or equal to 50 mW.

Using the methods disclosed herein, a circuit architecture comprising with high-confinement SOAs can be configured. Such implementations can be associated with increased power efficiency of the circuit architecture. In addition, a circuit architecture comprising high-confinement SOAs can be compatible with epitaxy and lithography that support high-efficiency splitters, combiners, and other standard integrated photonic elements.

If each stage of a tree splits an output of an optical amplification module into M outputs and the tree comprises N stages, the tree can have MAN optical ports. In some examples, these optical ports can be optionally recombined into a smaller number of optical ports. For instance, in some implementations, two or more optical ports can be combined into one optical port. In some examples, a plurality of optical ports can be combined into one optical port. In other words, a circuit architecture can comprise an optical combining arrangement configured to combine at least a portion of an optical wave from each optical port of two or more optical ports of the plurality of optical ports into an optical wave.

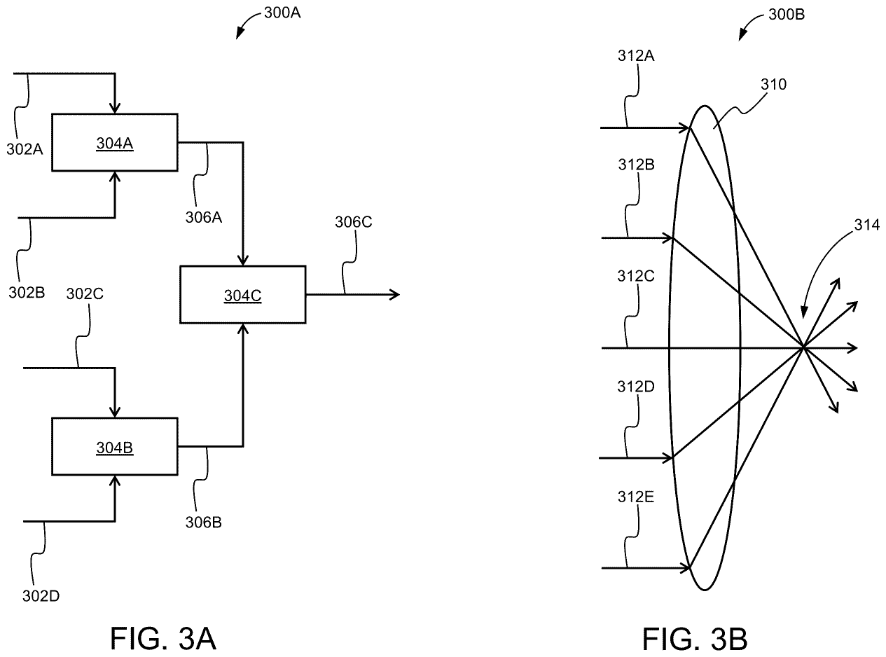

FIG. 1D depicts an example circuit architecture 100D. The circuit architecture 100D comprises a similar configuration to the circuit architecture 100A as well as an optical combining arrangement. In this example, the optical combining arrangement comprises an optical combiner 110. The optical combiner is configured to combine at least a portion of an optical wave from each optical port of the plurality of optical ports 108A-108D into an optical port 112, i.e., an output. Example optical combiners are shown in FIGS. 3A-3B and described later.

In some examples, optical power splitting modules can be configured to split optical power in one direction and combine optical power in another direction. Such configurations can be referred to as optical power splitting/combining modules. Some optical combining arrangements can utilize the plurality of optical power splitting/combining modules to combine optical waves. FIG. 1E depicts an example circuit architecture 100E comprising a similar configuration to the circuit architecture 100A. In this example, each optical port of the plurality of optical ports 108A-108D is in optical communication with a respective optical reflector of a plurality of optical reflectors 114A-114D. In other words, the optical port 108A is in optical communication with an optical reflector 114A, the optical port 108B is in optical communication with an optical reflector 114B, the optical port 108C is in optical communication with an optical reflector 114C, and the optical port 108D is in optical communication with an optical reflector 114D. Each optical reflector of the plurality of optical reflectors 114A-114D is at least partially reflective to one or more optical wavelengths of optical waves provided by the plurality of optical ports 108A-108D. This configuration allows optical waves to be reflected back through the plurality of optical power splitting modules 106A-106C such that one or more optical power splitting modules of the plurality of optical power splitting modules 106A-106C can be used to combine optical waves. By way of example, an optical wave propagating from the optical power splitting module 106B is provided via the optical amplification module 104C and the optical port 108A to the optical reflector 114A, which reflects the optical wave back to the optical power splitting module 106B. Similarly, an optical wave propagating from the optical power splitting module 106B is provided via the optical amplification module 104D and the optical port 108B to the optical reflector 114B, which reflects the optical wave back to the optical power splitting module 106B. The optical power splitting module 106B combines these optical waves into an optical wave that is provided to the optical power splitting module 106A via the optical amplification module 104A.

In some implementations, one or more optical reflectors of the plurality of optical reflectors 114A-114D can be portions of one or more reflective elements. Alternatively, each optical reflector of the plurality of optical reflectors 114A-114D can be individual reflective elements.

Some optical amplification modules can be configured to apply a gain to an optical wave in response to a control signal provided to the optical amplification module. In some examples, external circuitry can be configured to provide a control signal to each optical amplification module of a plurality of optical amplification modules. FIG. 1F depicts an example circuit architecture 100F comprising a similar configuration to the circuit architecture 100B. In this example, the circuit architecture 100F further comprises control circuitry 116. The control circuitry is configured to provide a respective control signal to each optical amplification module of the plurality of optical amplification modules 104A-104G.

In some examples, control circuitry 116 can be configured to provide control signals based on feedback from optical waves. In some examples, a measurement of a characteristic of an optical wave can provide this feedback. Some characteristics of optical waves include, but are not limited to, polarization, optical power, optical phase, or optical wavelength. In other words, control circuitry 116 can be configured to provide control signals based at least in part on a measurement of an optical wave. By way of example, one or more optical ports of the plurality of optical ports 108A-108D can be in optical communication with a photodetector, such as a photodiode, that can convert optical signals to electrical signals. The photodetector can measure a characteristic of an optical wave, i.e., an optical power, at the one or more optical ports of the plurality of optical ports 108A-108D and the control circuitry 116 can provide control signals based at least in part on a result of the measurements. Other examples are described later in more detail.

FIG. 1G depicts an example circuit architecture 100G comprising a similar configuration as the circuit architecture 100D. In this example, the circuit architecture 100G comprises control circuitry 116. The control circuitry 116 is configured to receive feedback from the optical port 112, i.e., a measurement of a portion of an optical wave at the optical port 112. The control circuitry 116 can be configured to apply control signals to each optical amplification module of the plurality of optical amplification modules 104A-104G based at least in part on this measurement.

FIG. 1H depicts a portion 100H of an example circuit architecture comprising an optical power splitting module 126 associated with an insertion loss ηₛₚₗᵢₜ and a plurality of optical amplification modules 124A-124N, i.e., an optical amplification module 124A, an optical amplification module 124B, and an optical amplification module 124N. An optical wave having an input power P_{crit} is directed into the optical power splitting module 126. The optical power splitting module 126 directs portions of the optical wave according to a power splitting module to the N outputs such that the optical power in each output is P_{crit}ηₛₚₗᵢₜ/N. Each optical amplification module of the plurality of optical amplification modules 124A-124N is configured to apply a gain of N/ηₛₚₗᵢₜ to an optical wave such that the optical power following that optical amplification module is P_{crit}.

FIG. 1I depicts an example circuit architecture 1001 comprising a similar configuration to the circuit architecture 100A. As shown in FIG. 1I, the optical power splitting module 106B is configured to provide optical waves to the optical port 108A and the optical port 108B along optical paths having a first optical path length. The optical power splitting module 106C is configured to provide optical waves to the optical port 108C and the optical port 108D along optical paths having a second optical path length. In this example, the first optical path length is different from the second optical path length. Such implementations can allow for back-reflections or backward-propagating optical waves traveling from the optical ports to the input port 102 from being amplified constructively in the reverse path of the optical amplifier, which can interfere with forward-propagating waves. This interference can result in a loss of optical power produced by a circuit architecture. In other words, configuring different optical path lengths can prevent optical feedback from coherently accumulating in the circuit architecture.

In other words, at least one path along which an optical power splitting module of the plurality of optical power splitting modules provides an optical wave has an optical path length that is different from an optical path length of a path along which a different optical power splitting module of the plurality of optical power splitting modules provides an optical wave.

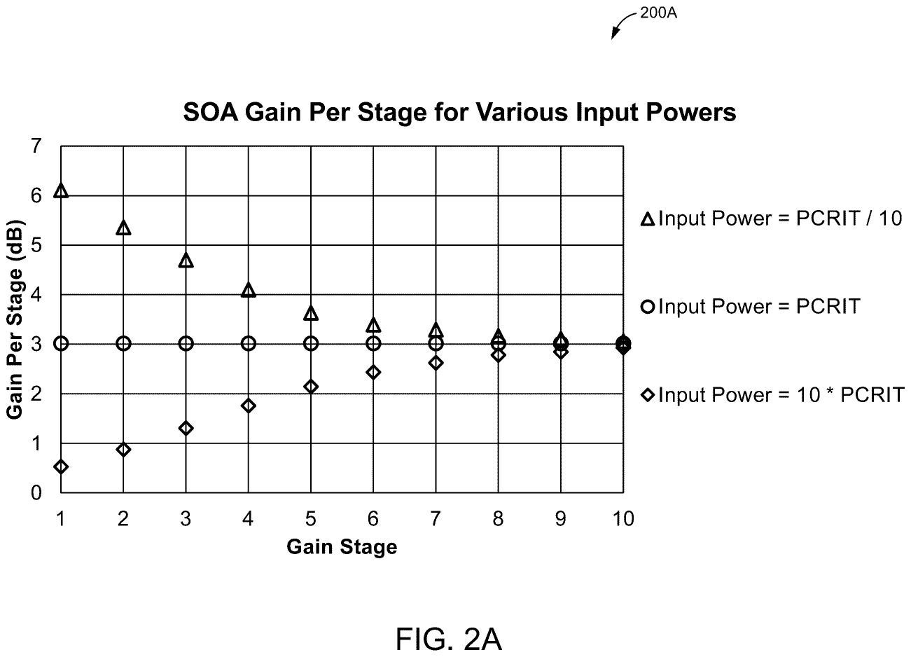

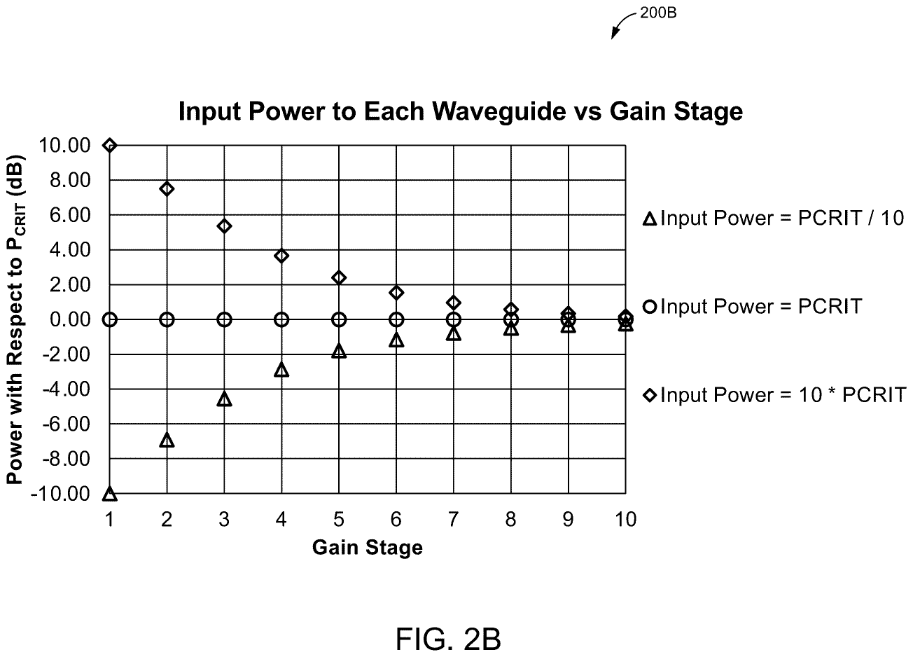

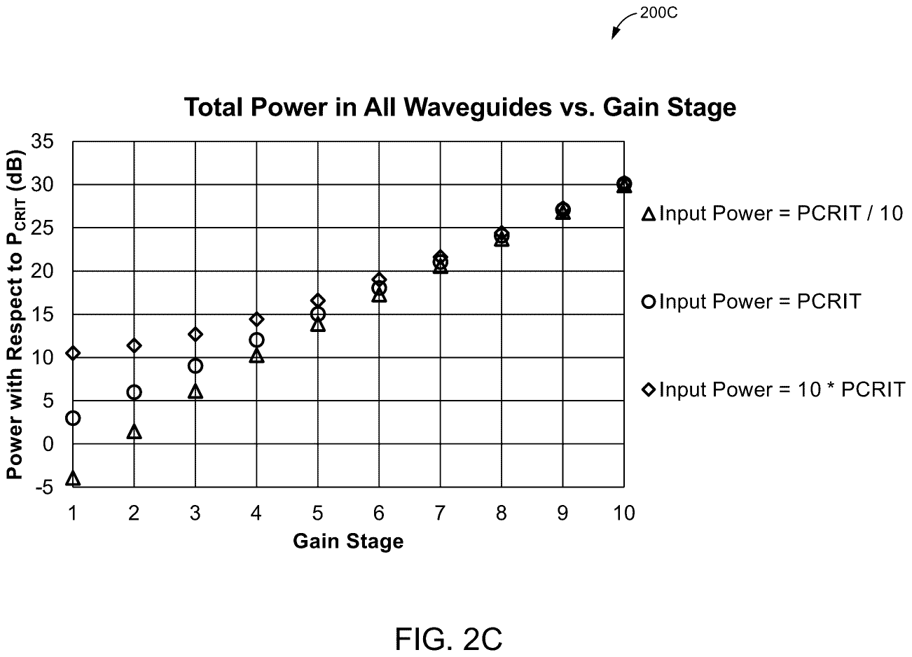

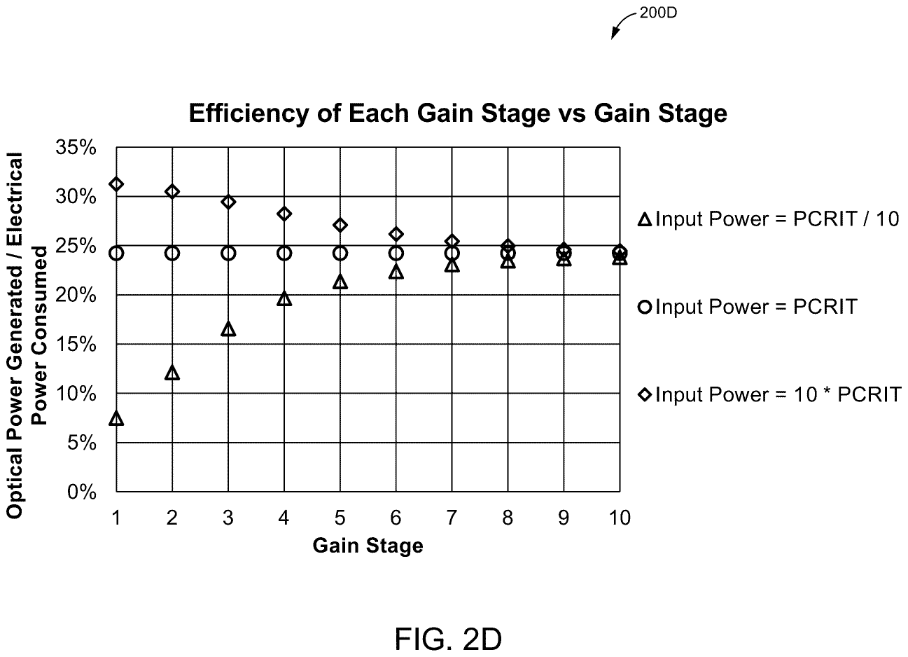

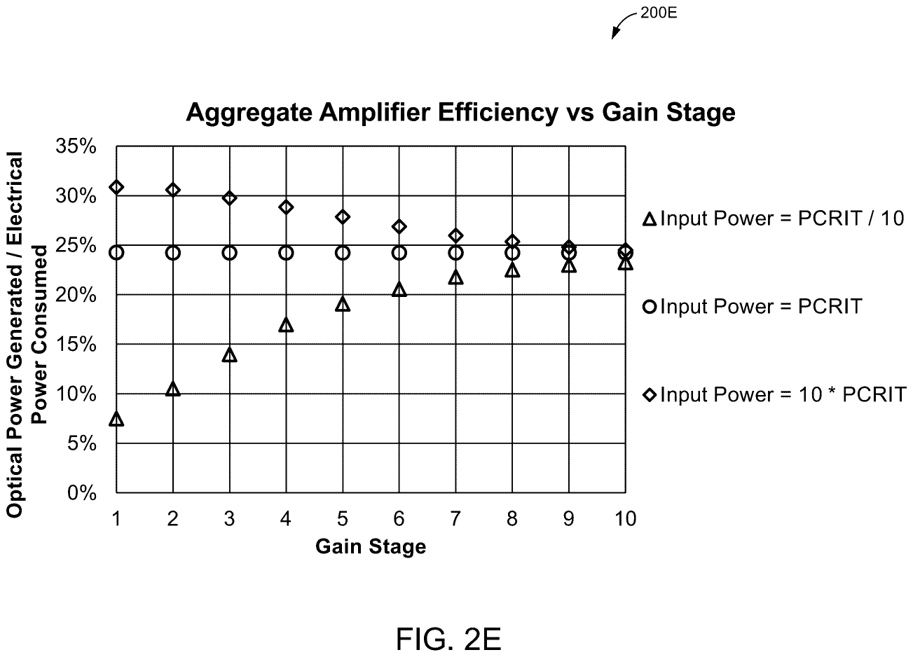

Assuming sufficiently strong pumping of each SOA and in the limit with enough amplification stages, the gain in the SOAs can self-adjust so that the optical power arriving at each SOA approaches the critical power. FIGS. 2A-2E depict plots 200A-200E of numerical simulations associated with configuring a circuit architecture. Each of the plots 200A-200E depict three traces associated with cases: (1) when the input power is lower than the critical power (triangle trace), (2) when the input power is equal to the critical power (circle trace), and (3) when the input power is more than the critical power (diamond trace). FIG. 2A depicts a plot 200A of numerical simulations of the gain per stage vs. the number of gain stages associated with a circuit architecture. FIG. 2B depicts a plot 200B of numerical simulations of the input power with respect to P_{crit} vs. the number of gain stages associated with a circuit architecture. FIG. 2C depicts a plot 200C of numerical simulations of the total power in all waveguides with respect to P_{crit} vs. the number of gain stages associated with a circuit architecture. FIG. 2D depicts a plot 200D of numerical simulations of the efficiency of each gain stage vs. the number of gain stages associated with a circuit architecture. In this example, the efficiency of each gain stage is associated with the optical power generated divided by the electrical power consumed by that gain stage. FIG. 2E depicts a plot 200E of numerical simulations of the aggregate amplifier efficiency vs. the number of gain stages associated with a circuit architecture. In this example, the aggregate amplifier efficiency is associated with the optical power generated divided by the electrical power consumed of the gain stages. As shown in FIG. 2C, both total output power and aggregate gain increase linearly with the number of stages in the amplifier.

Because the staged amplifier can drive itself towards a configuration where each amplification stage is operating close to saturation, each amplification stage can operate close to the peak efficiency of the amplifier. As shown in FIG. 2D, the efficiency of the SOA elements towards the latter gain stages can tend towards the efficiency of a device that is provided with input power at the critical power. FIG. 2E shows the simulated efficiency for the same device but calculates the efficiency of the aggregate amplifier up to the point of that gain stage, instead of just the incremental efficiency of each gain stage. Towards the latter gain stages, the aggregate efficiency of the amplifier can match the incremental efficiency of that same gain stage. This trend is associated with the addition of far more power in the latter gain stages than in earlier gain stages due to the large number of amplifiers at the end of the device. When compared to other amplifiers where light is amplified in a uniformly shaped waveguide, the efficiency benefit becomes apparent, as the power consumed to amplify light at the beginning of the conventional amplifier can be a meaningful fraction of the power consumed by the SOA without contributing a meaningful fraction of optical output power.

In some implementations, SOAs can be used in applications where an optical input is linearly amplified. However, such implementations can be associated with saturation effects that can degrade system performance. For instance, in communication systems where information is encoded using the intensity of light, amplifiers operating at saturation can degrade the quality of the transmitted waveform. Using the methods disclosed herein, an optical amplifier may be configured to operate in a different regime so that linear amplification is achieved. Instead of pumping the SOAs with sufficient current to achieve more gain than the combined losses due to splitting and insertion loss, the SOA elements may be pumped with a gain greater than one but less than the critical gain. In this case, the power arriving at each SOA element can tend to decrease with increasing gain stage. This implementation can allow for the SOAs to operate in the linear regime, even towards the end of the amplifier. Trees that split the output of each SOA into more than two waveguide outputs may be desirable for amplifiers intended to operate in the linear regime, as the critical gain increases with the number of waveguides that the SOA outputs are split into, enabling more gain per stage while still operating in the linear regime.

As previously described, some circuit architectures can comprise an optical combining arrangement. FIG. 3A depicts an example circuit architecture 300A that can be used as an optical combining arrangement. The circuit architecture 300A comprises a plurality of optical ports 302A-302D, i.e., an optical port 302A, an optical port 302B, an optical port 302C, and an optical port 302D. The circuit architecture 300A further comprises a plurality of optical power combining modules 304A-304C, sometimes referred to as optical combining modules. Each optical power combining module of the plurality of optical power combining modules 304A-304C is configured to combine at least a portion of two or more optical waves into an optical wave in an optical port of a plurality of optical ports 306A-306C. By way of example, the optical power combining module 304A combines at least a portion of an optical wave from the optical port 302A and at least a portion of an optical wave from the optical port 302B into the optical port 306A. The optical combining module 304B combines at least a portion of an optical wave from the optical port 302C and at least a portion of an optical wave from the optical port 302D into the optical port 306B. The optical combining module 304C combines at least a portion of an optical wave from the optical port 306A and at least a portion of an optical wave from the optical port 306B into the optical port 306C.

In other words, the circuit architecture 300A comprises a plurality of 2×1 beam combiners that are connected in a tree configuration such that each stage halves the number of waveguides in comparison to the previous stage. In the circuit architecture 300A, four inputs are combined into one output in 2 stages. In this example, each optical power combining module of the plurality of optical power combining modules 304A-304C is configured as a 2×1 power combiner. Other arrangements, e.g., 3×1, 4×1, 2×2, or 2×3, and mixtures of arrangements may also be utilized.

FIG. 3B depicts an example of an optical combining arrangement 300B. In this example, an optical component 310 is configured to combine at least a portion of an optical wave from each optical port of a plurality of optical ports 312A-312E, i.e., an optical port 312A, an optical port 312B, an optical port 312C, an optical port 312D, and an optical port 312E. In this example, the optical component 310 is configured as a free-space optical lens that is at least partially transparent. In other words, the optical component 310 is a free-space optical combining arrangement. The optical component 310 is configured to combine at least a portion of an optical wave from each optical port of a plurality of optical ports 312A-312E into an optical wave, i.e., a spatial mode 314.

Other examples of optical combining arrangements can comprise combining elements such as, but are not limited to, multimode interferometers that combine more than two waveguide inputs into a single input, planar lenses, free-space lenses, or beam combiners. Some optical combining arrangements can also include a free-space optical element that is partially reflective and configured to combine portions of optical waves into an optical wave. For instance, a concave mirror can be used as an optical combining arrangement.

In some implementations, a circuit architecture can be configured such that the optical waves provided by optical ports are in phase with each other. Such implementations can be beneficial in various applications. By way of example, the optical ports can be in optical communication with an optical component such as an optical phased array. Alternatively, an optical combining arrangement can combine optical waves with higher efficiency if the optical waves are in phase. Manufacturing defects, thermal gradients, or phase changes induced by optical amplification modules can cause the phase of light at each optical port to be unpredictable. To compensate for unpredictable phase errors, some circuit architectures can further comprise components such as phase modulation modules that are configured to apply a phase modulation to an optical wave propagating through the phase modulation module. In some implementations, a plurality of phase modulation modules can be distributed throughout a circuit architecture. Some phase modulation modules can be optical phase shifters, for example, electro-optic, thermal, liquid crystal, plasma dispersion, pn junction phase shifters. Some phase modulation modules can be configured to apply a phase modulation to an optical wave in response to a control signal provided to the phase modulation module. In some examples, each phase modulation module of a plurality of phase modulation modules can be controlled independently, i.e., by different control signals. In some examples, two or more phase modulation modules of a plurality of phase modulation modules can be jointly controlled, i.e., by one control signal.

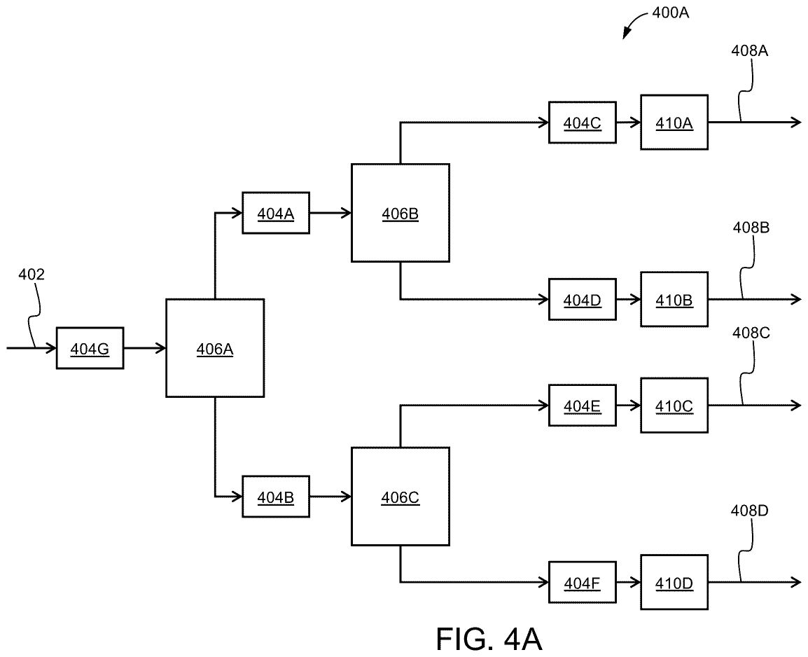

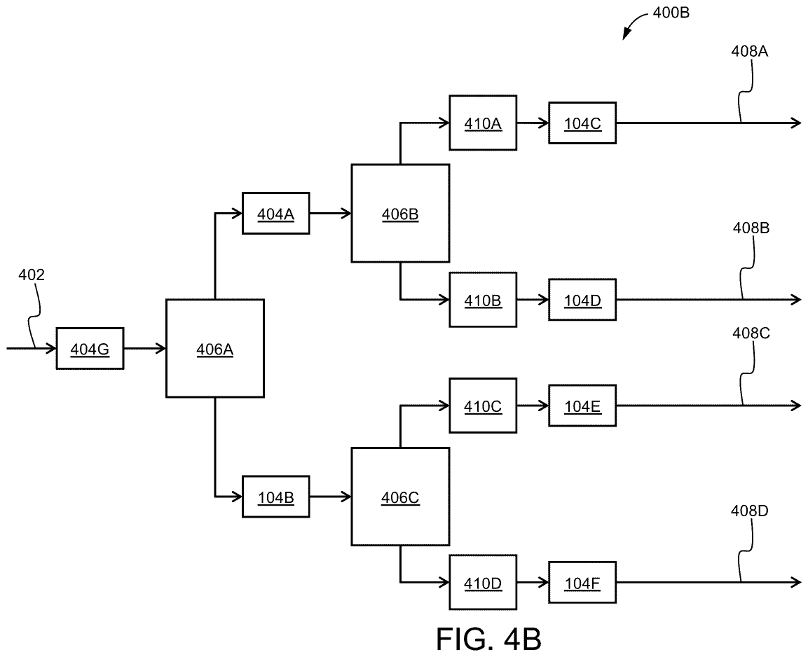

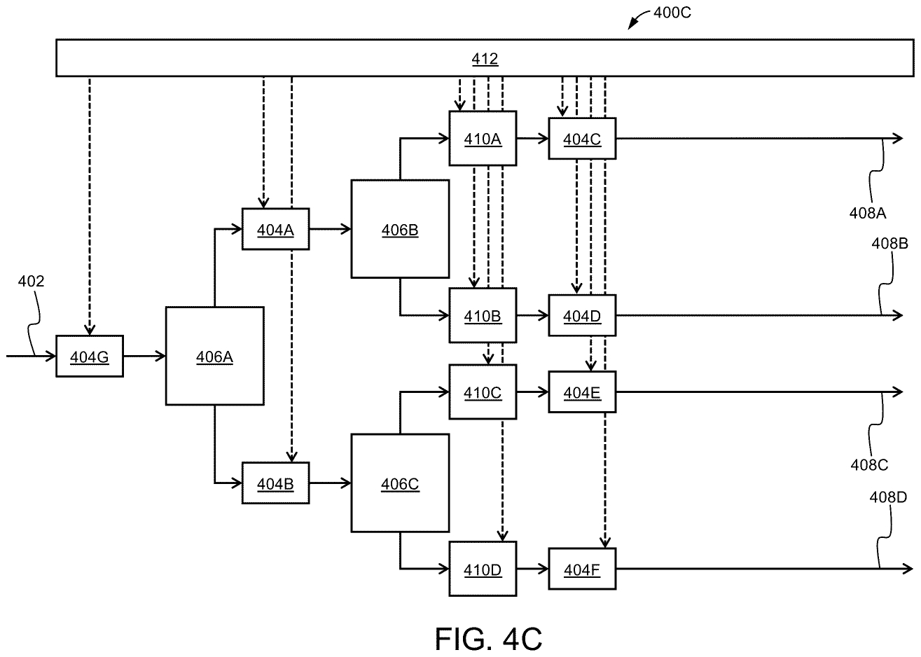

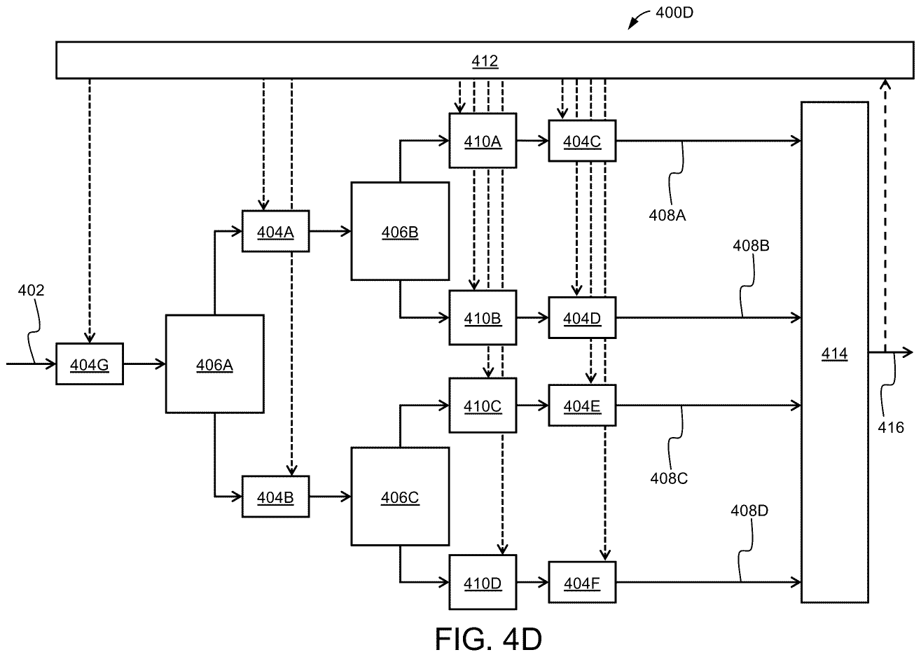

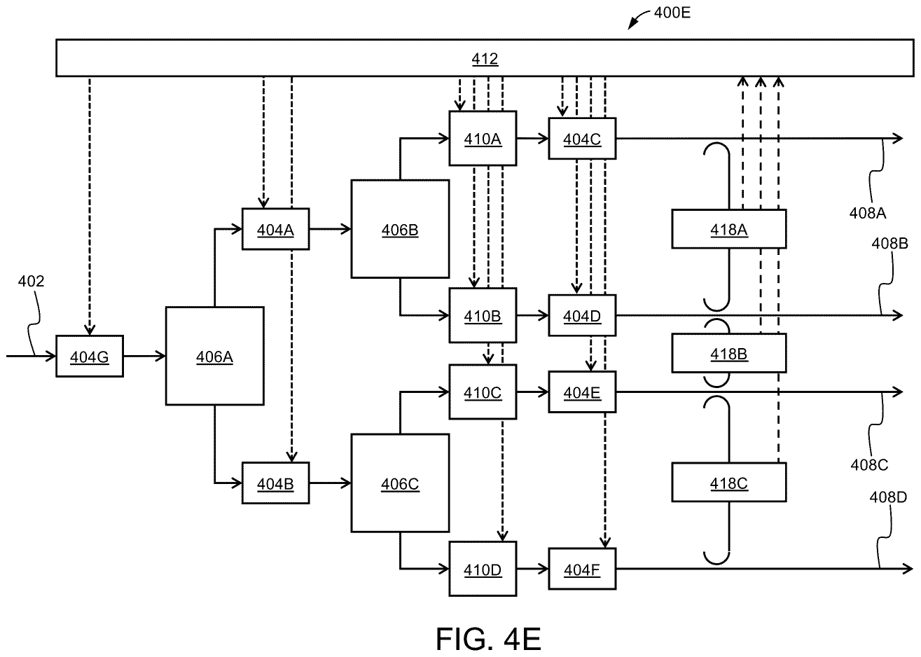

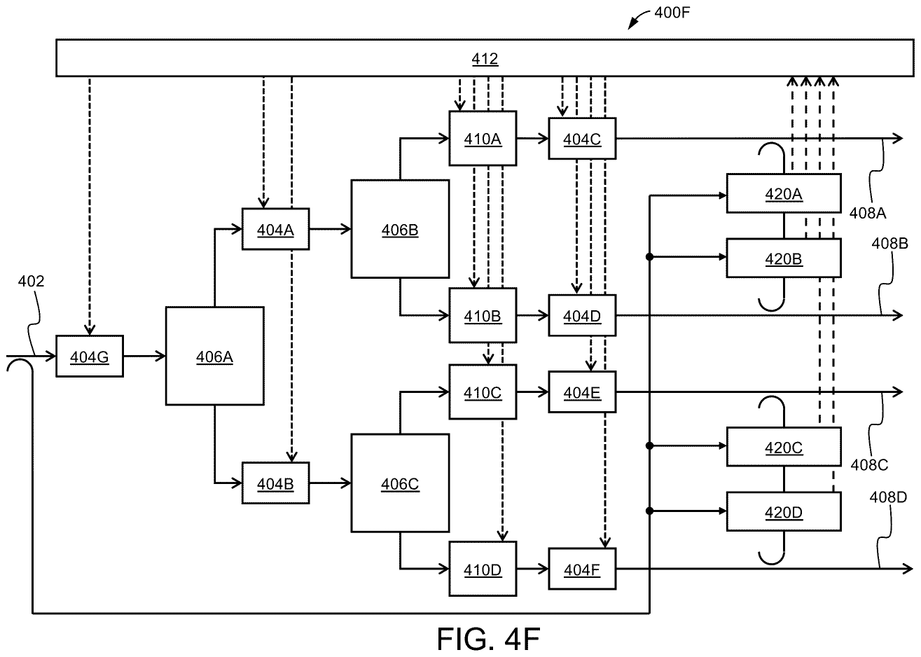

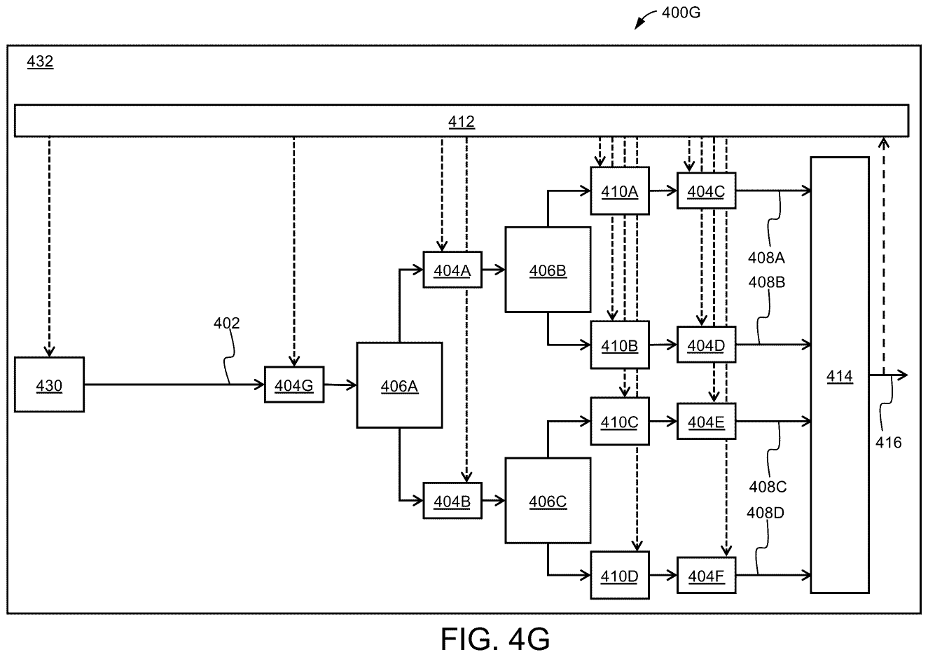

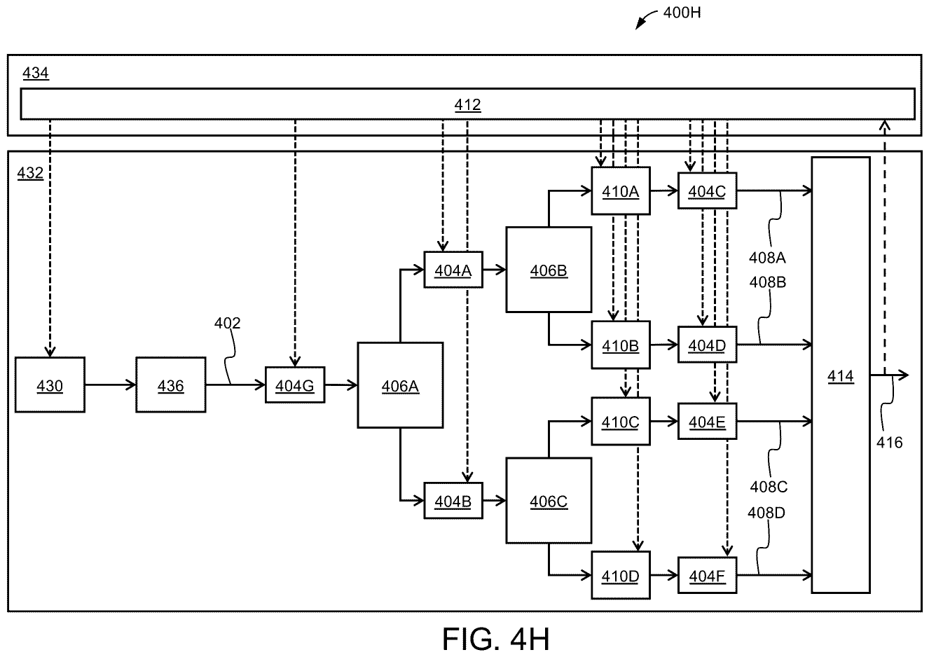

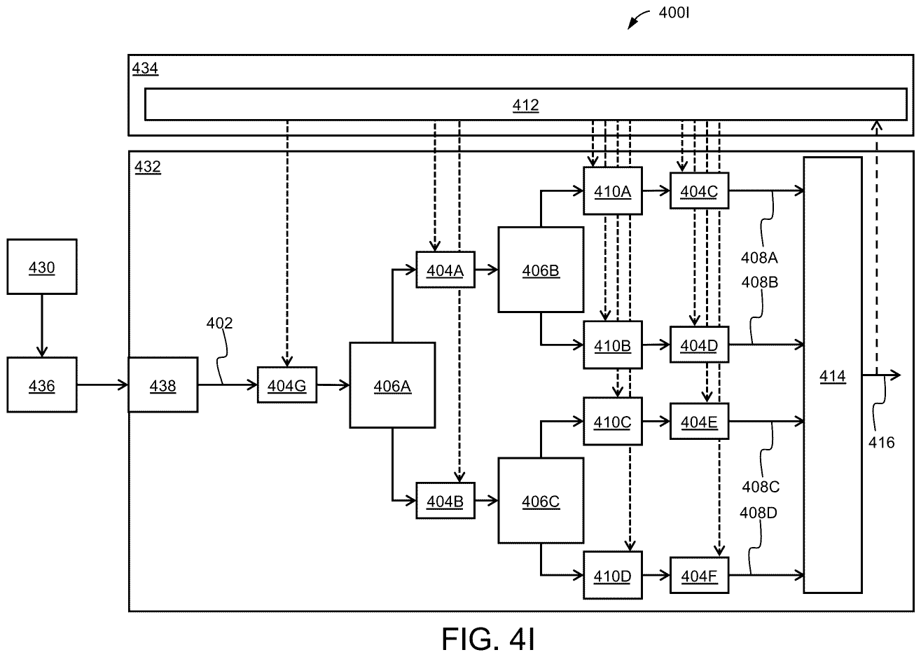

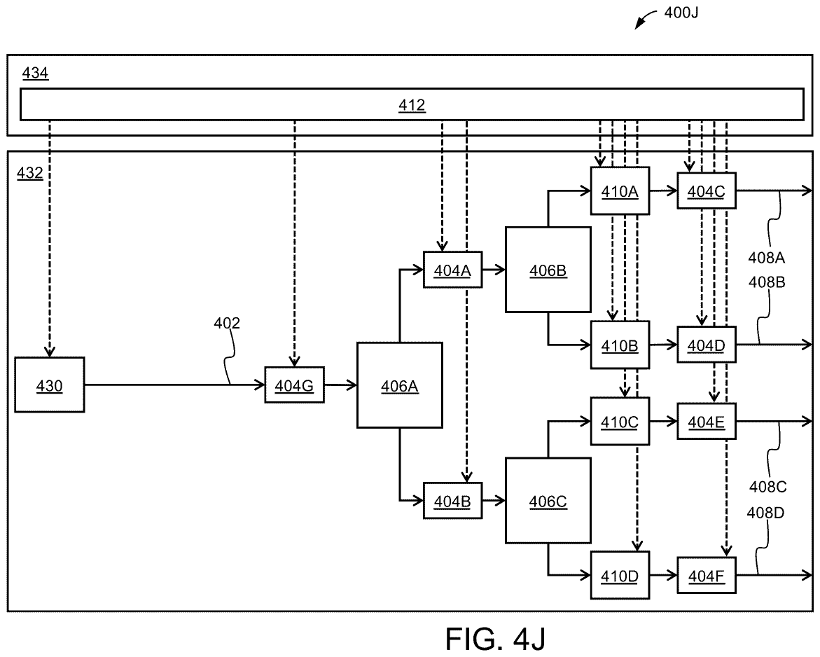

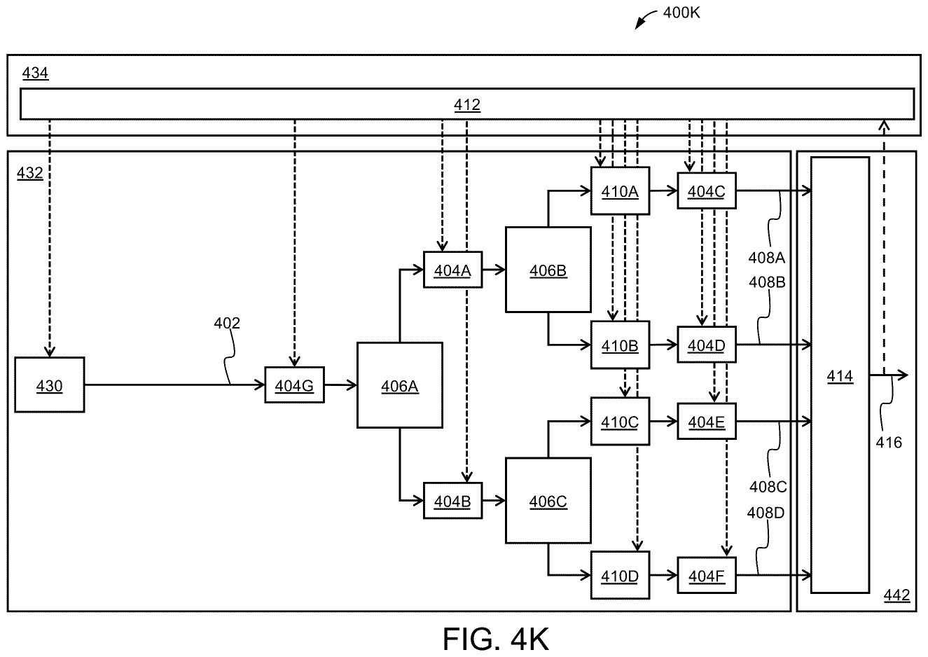

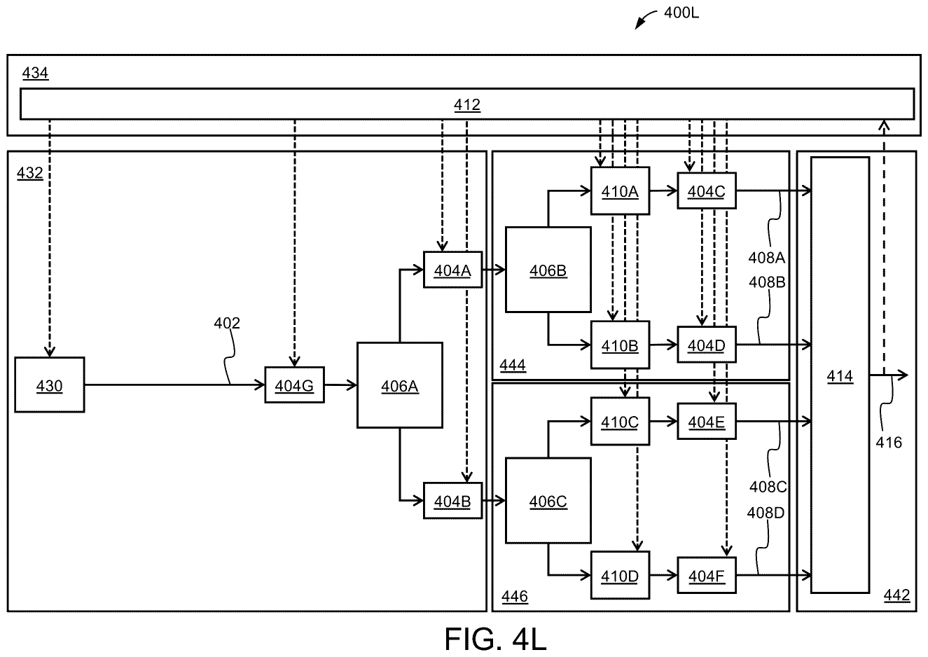

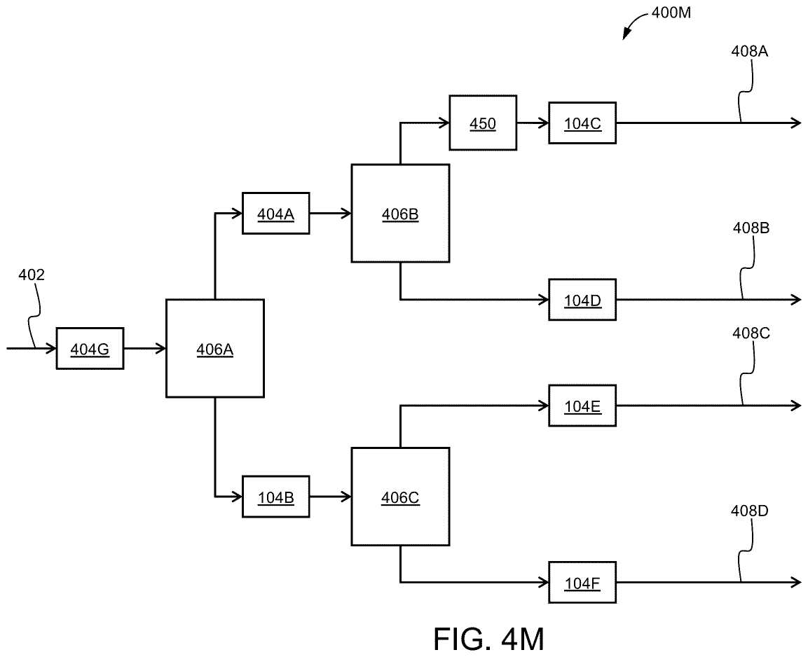

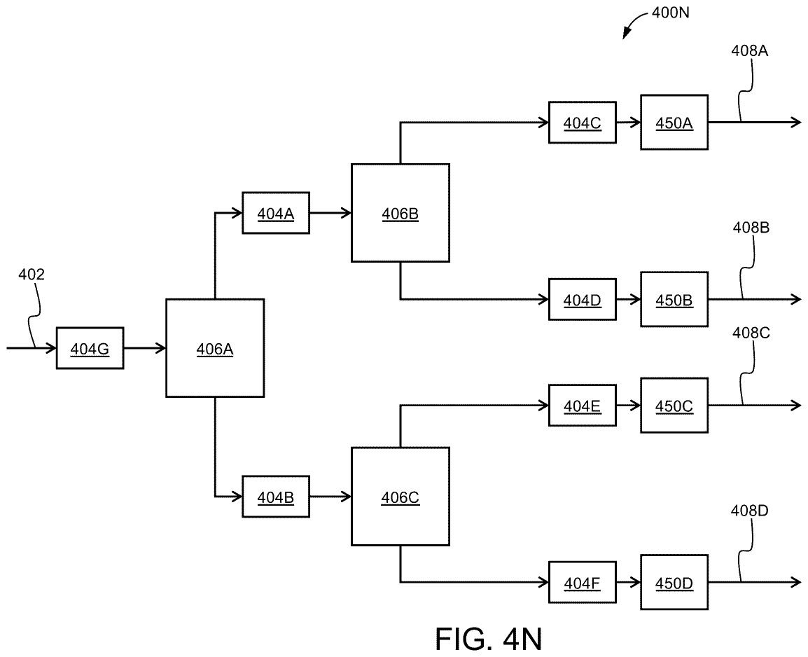

FIG. 4A depicts an example circuit architecture 400A comprising a similar configuration to the circuit architecture 100B. The circuit architecture 400A comprises an input port 402 and a plurality of optical amplification modules 404A-404G, i.e., an optical amplification module 404A, an optical amplification module 404B, an optical amplification module 404C, an optical amplification module 404D, an optical amplification module 404E, an optical amplification module 404F, and an optical amplification module 404G. The circuit architecture 400A further comprises a plurality of optical power splitting modules 406A-406C, i.e., an optical power splitting module 406A, an optical power splitting module 406B, and an optical power splitting module 406C. The circuit architecture 400A further comprises a plurality of optical ports 408A-408D, i.e., an optical port 408A, an optical port 408B, an optical port 408C, and an optical port 408D. The circuit architecture 400A further comprises a plurality of phase modulation modules 410A-410D, i.e., a phase modulation module 410A, a phase modulation module 410B, a phase modulation module 410C, and a phase modulation module 410D. In this example, each phase modulation module of the plurality of phase modulation modules 410A-410D is in optical communication with an optical amplification module of the plurality of optical amplification modules 404A-404G and an optical port of the plurality of optical ports 408A-408D.

Some circuit architectures can comprise other configurations of phase modulation modules. FIG. 4B depicts an example circuit architecture 400B comprising a similar configuration and components as the circuit architecture 400A. In this example, each phase modulation module of the plurality of phase modulation modules 410A-410D is in optical communication with an optical amplification module of the plurality of optical amplification modules 404A-404G and an optical power splitting module of the plurality of optical power splitting modules 406A-406C.

As shown in FIGS. 4A-4B, the phase modulation modules of the plurality of phase modulation modules 410A-410D are in communication with a respective optical port of the plurality of optical ports 408A-408D. Configuring the plurality of phase modulation modules 410A-410D in this way can allow for the phase of optical waves arriving at each optical port to be controlled individually. Alternatively, other implementations can distribute phase modulation modules throughout a circuit architecture. For instance, phase modulation modules can be included after the optical power splitting module 406A.

In some implementations, incorporating a plurality of phase modulation modules throughout a circuit architecture, or tree, can be associated with advantages in that each phase modulation module can be used to apply small amounts of phase modulation to optical waves, which can reduce power consumption. Some circuit architectures can comprise other configurations or combinations of phase splitting modules. For instance, phase modulation modules can be included before or after the optical amplification module 404A or the optical amplification module 404B. Alternatively, one or more phase modulation modules of the plurality of phase modulation modules 410A-410D can be omitted. In some examples, incorporating at least two phase modulation modules in a circuit architecture can be useful to control phases of optical waves propagating through different optical waveguides, especially in circuit architectures comprising optical combining arrangements.

In some examples, each of the circuit architecture 400A or the circuit architecture 400B can comprise an optical combining arrangement as described previously. Some optical combining arrangements, such as the example shown in FIG. 3A, can comprise optical waveguiding structures such that phase modulation modules can be distributed throughout the optical combining arrangement.

Some phase modulation modules can be configured to apply a phase modulation to an optical wave in response to a control signal provided to the phase modulation module. Likewise, some optical amplification modules can be configured to apply a gain to an optical wave in response to a control signal provided to the optical amplification module. In some implementations, control signals can be provided by control circuitry. FIG. 4C depicts an example circuit architecture 400C comprising a similar configuration to the circuit architecture 400B. The circuit architecture 400C further comprises control circuitry 412 in communication with each optical amplification module of the plurality of optical amplification modules 404A-404G and each phase modulation module of the plurality of phase modulation modules 410A-410D. In some examples, the control circuitry 412 can be in electrical communication with components via conductive structures that are configured to carry electrical signals between one or more chips or one or more layers of chips.

In some implementations, control circuitry can be configured to apply control signals based at least in part on feedback from a circuit architecture. Some examples of feedback include measurements of optical power or optical phase in a circuit architecture. By way of example, FIG. 4D depicts an example circuit architecture 400D comprising a similar configuration to the circuit architecture 400C. The circuit architecture 400D further comprises an optical combining arrangement 414 that is configured to combine optical waves from the plurality of optical ports 408A-408D into an optical wave 416. Optical power of at least a portion of the optical wave 416 can be measured following the optical combining arrangement 414 using a detecting element, such as a photodetector or photodiode. The control circuitry 412 can then generate a control signal based at least in part on the measurement of optical power. In other words, a control signal can be generated based at least in part on a measurement of an optical wave produced by the optical combining arrangement. In other words, the power at the output of the combining element can be monitored to provide feedback for closed-loop control of the beam combination.

In some implementations, a control loop can be used to tune the efficiency of optical combination by monitoring an output power produced by an optical circuit and tuning parameters of the optical circuit to increase or decrease the output power. By way of example, an output power can be increased or maximized by tuning parameters such as phase modulation or optical amplification applied to optical waves. In such a control scheme, a feedback element can generate a control signal proportional to the power in one or more output waveguides and electronics adjust control signals that drive the phase shifting elements or phase modulation elements to increase or maximize the output power produced by the optical circuit.

Some optical combining arrangements can produce one or more optical waves. For instance, some optical combining arrangements can comprise optical power splitters having one or more output ports. In some examples, phase modulations applied to optical waves can be used to vary an optical power in output ports of the optical combining arrangement.

Beam combination efficiency may also be tuned or maximized using a control loop that monitors the phase of light in one or more waveguides relative to one or more reference optical signals prior to combining the light from multiple waveguides. FIG. 4E depicts an example circuit architecture 400E comprising a similar configuration as the circuit architecture 400C. In this example, a plurality of detectors 418A-418C, i.e., a detector 418A, a detector 418B, and a detector 418C, are in optical communication with the plurality of optical ports 408A-408D via optical splitters configured to provide portions of optical waves to the plurality of detectors 418A-418C. Each detector of the plurality of detectors 418A-418C is configured to measure portions of optical waves provided to the plurality of optical ports 408A-408D. In some examples, each detector of the plurality of detectors 418A-418C can be configured to measure a phase of an optical wave. In some implementations, each detector of the plurality of detectors 418A-418C can comprise a respective in-phase/quadrature-phase (IQ) detector. In this example, each detector of the plurality of detectors 418A-418C is configured to compare phases of optical waves provided to adjacent pairs of output ports of the plurality of output ports 408A-408D. Other combinations of output ports can also be measured or compared. Each detector of the plurality of detectors 418A-418C is in communication with the control circuitry 412. The control circuitry 412 can be configured to provide control signals that are generated based at least in part on one or more measurements of optical waves by the plurality of detectors 418A-418C.

FIG. 4F depicts an example circuit architecture 400F comprising a similar configuration as the circuit architecture 400C. The circuit architecture 400F further comprises a plurality of detectors 420A-420D, i.e., a detector 420A, a detector 420B, a detector 420C, and a detector 420D. Each detector of the plurality of detectors 420A-420D is configured to measure portions of optical waves provided to the plurality of optical ports 408A-408D. In this example, a portion of an optical wave at the input port 402 is provided to each detector of the plurality of detectors 420A-420D. In some implementations, each detector of the plurality of detectors 420A-420D can comprise a respective IQ detector such that the plurality of detectors 420A-420D is configured to measure phases of optical waves provided to the plurality of optical ports 408A-408D. While the circuit architecture 400F depicts each optical port of the plurality of optical ports 408A-408D as being in optical communication with a respective detector of the plurality of detectors 420A-420D, some configurations can use one or more detectors to measure phases of optical waves. Each detector of the plurality of detectors 420A-420D is in communication with the control circuitry 412. The control circuitry 412 can be configured to provide control signals that are generated based at least in part on one or more measurements of optical waves by the plurality of detectors 420A-420D.

While not shown in FIGS. 4E-4F, optical combining arrangements can also be included to combine portions of optical waves from the plurality of optical ports 408A-408D.

In some implementations, an optical amplification module can be configured such that the optical amplification module can simultaneously apply gain to an optical wave and apply a phase modulation to an optical wave propagating through the optical amplification module. Referring back to FIGS. 1F-1G, the circuit architectures 100F-100G can comprise optical amplification modules that can apply a gain and a phase modulation. Some optical amplification modules can change the phase of light through the thermo-optic effect and through the plasma-dispersion effect. Changing the pump current or drive voltage controlling each optical amplification module in the tree can adjust both the temperature, i.e., due to changes in power dissipation, and free carrier concentration, serving as actuation authority that can allow phase to be modulated at the output of each optical amplification module.

In some implementations, providing multiple outputs from the photonic integrated circuit with the intent of concentrating the output power from each waveguide to a remote point such as a location in a semiconductor waveguide, fiber-optic waveguide, or free-space, can be associated with advantages. This configuration may be useful, among other cases, if more output power is desired than can be handled in a single waveguide associated with a circuit architecture or an integrated photonic circuit. In such implementations, phase control may be used to increase or maximize power at a remotely measured location in addition to or instead of increasing or maximizing power in the on-chip waveguides.

As previously described, some circuit architectures can be distributed across multiple chips or consolidated onto a single chip. Returning to FIG. 4D, the circuit architecture 400D can be arranged on a single chip. Alternatively, the control circuitry 412 can be arranged on a first chip while other portions of the circuit architecture 400D can be arranged on a second chip in communication with the first chip. Alternatively, the control circuitry 412 can be arranged on a first chip, the optical combining arrangement 414 can be arranged on a second chip, and other portions of the circuit architecture 400D can be arranged on a third chip, where each of the first chip, the second chip, and the third chip are in communication with each other. In some examples, arranging a circuit architecture across multiple chips can allow for portions of the circuit architecture to be integrated into chips that can have different properties. By way of example, chips comprising materials such as silicon nitride can handle higher optical powers in waveguides and can have lower losses compared to other materials. Some circuit architectures can be configured such that some portions of the circuit architecture are formed in a layer of chip comprising a first material while other portions of the circuit architecture are formed in a layer of a chip comprising a second material. Such implementations can allow for reduced optical losses or higher optical powers in selected portions of the circuit architecture.

Some circuit architectures can also include an optical source that is in optical communication with portions of the circuit architecture via the input port. In some examples, an optical source can be integrated on the same chip as a circuit architecture, or can be a separate device configured to provide an optical wave that is coupled into a chip via optical structures such as free-space optical elements or optical fibers.

By way of example, FIGS. 4G-4I depict example circuit architectures 400G-400I. FIG. 4G depicts an example circuit architecture 400G comprising a similar configuration to the circuit architecture 400D. The circuit architecture 400G further comprises an optical source 430 that provides an optical wave to the input port 402. In this example, portions of the circuit architecture 400G including the optical source 430 and the control circuitry 412, is arranged in a layer of a first chip 432. The control circuitry 412 is further configured to provide a control signal to the optical source 430.

FIG. 4H depicts an example circuit architecture 400H wherein portions of the circuit architecture 400H are arranged on the first chip 432 and a second chip 434. As shown in FIG. 4H, the control circuitry 412 is arranged on the second chip 434. In this example, the optical source 430 provides an optical wave to the input port 402 via an optical isolator 436. Some optical isolators can prevent back-reflections or back-reflected optical waves propagating back toward the optical source, which can affect the performance of the optical source.

FIG. 4I depicts an example circuit architecture 400I wherein portions of the circuit architecture are arranged on the first chip 432. In this example, the optical source 430 is coupled into the input port 402 via a coupler 438. The coupler 438 is arranged at an edge or a surface of the first chip 432. In some implementations, the optical source 430 can be in a layer of another chip or can be a free-space optical source. In some examples, the optical source 430 can provide an optical wave to the coupler 438 via an optical isolator 436.

Some implementations can omit an optical isolator or optical combining arrangement. FIG. 4J depicts an example circuit architecture 400J, wherein the optical combining arrangement 414 is omitted. In some implementations, the plurality of optical ports 408A-408D can be provided as inputs to a secondary photonic configuration, such as an optical phased array or coherent beam combination module positioned on the first chip 432 or another chip. FIG. 4K depicts an example circuit architecture 400K, wherein the optical combining arrangement 414 is arranged in a layer of a third chip 442. FIG. 4L depicts an example circuit architecture 400L, wherein portions of circuit architecture are arranged in a layer of a fourth chip 444 and a fifth chip 446. Other combinations of chips and portions of circuit architectures are also possible.

Some implementations can comprise one or more filtering modules distributed in a circuit architecture. FIG. 4M depicts an example circuit architecture 400M comprising a filtering module 450. FIG. 4N depicts an example circuit architecture 400N comprising one or more filtering modules 450A-450D, i.e., a filtering module 450A, a filtering module 450B, a filtering module 450C, and a filtering module 450D, distributed throughout the circuit architecture 400N. As shown in FIG. 4N, each filtering module of the one or more filtering modules 450A-450D is in optical communication with an optical amplification module of the plurality of optical amplification modules or an optical power splitting module of the plurality of optical power splitting modules. In some examples, a circuit architecture can comprise a plurality of phase modulation modules and one or more filtering modules.

Some filtering modules can be configured to separate optical waves propagating through that filtering module of the one or more filtering modules. In some examples, a filtering module can comprise a wavelength filter configured to separate optical waves based at least in part on wavelengths of the optical waves. Examples of wavelength filters include ring resonators, Mach-Zehnder interferometers, and Bragg gratings. Such implementations can mitigate losses associated with optical waves with undesired optical wavelengths propagating through a circuit architecture. For instance, a wavelength filter can mitigate amplified spontaneous emission, which can reduce optical power at the output of a circuit architecture.

Some filtering modules can comprise a mode filter configured to separate optical waves based at least in part on an optical mode associated with an optical wave or a polarization of an optical wave. Examples of mode filters include spatial filters or polarization mode filters. Some implementations can mitigate losses associated with optical waves with undesired optical modes propagating through a circuit architecture. For instance, a mode filter can mitigate effects such as amplification of cross-polarization or higher-order spatial modes, which can reduce the efficiency of a circuit architecture.

In some implementations, a filtering module can comprise an optical isolator that is configured to allow optical waves to propagate in a first direction through the optical isolator and to prevent optical waves from propagating in a second direction opposite the first direction through the optical isolator. Including an optical isolator in a circuit architecture can prevent back-propagating optical waves from interacting with optical components. For instance, an optical isolator can be included between an optical source and an input port to prevent back-reflected optical waves from interfering with the optical source. In some implementations, an optical isolator can be included between a splitter tree and an optical combining arrangement 414 to manage back-reflections.

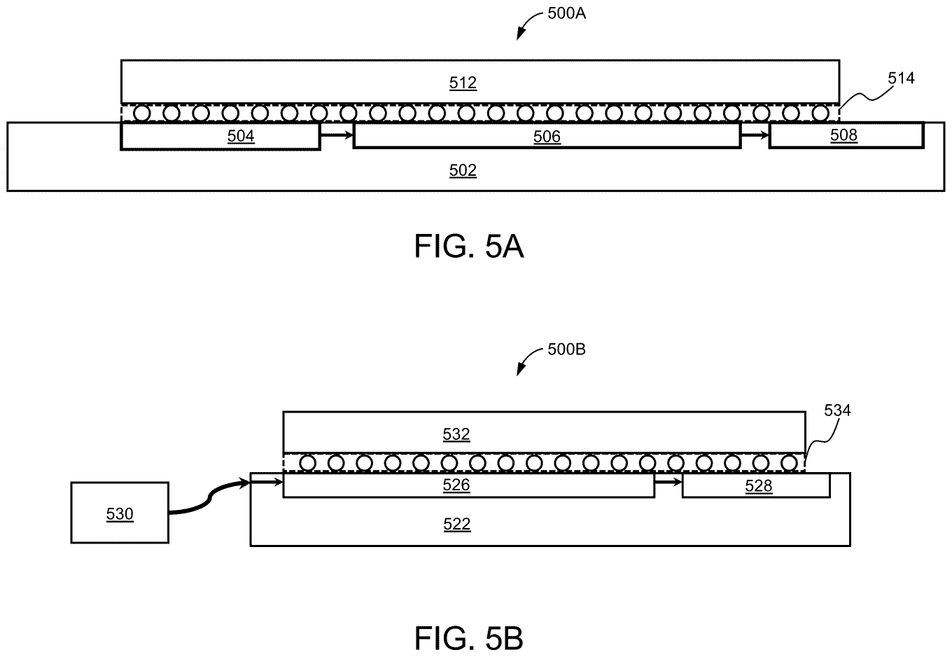

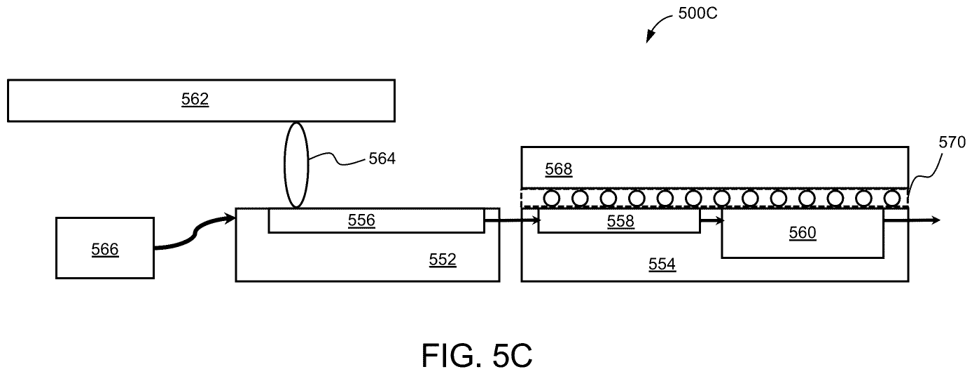

FIG. 5A depicts a side view of an example device 500A comprising a chip 502 of a first material. A circuit architecture is arranged in a layer of the chip 502. In this example, the chip 502 comprises an optical source 504, a circuit architecture 506, i.e., the circuit architectures depicted in FIGS. 1A-1G, and detectors 508 that are in communication with optical ports of the circuit architecture 506. The device 500A comprises an electronic integrated circuit 512 comprising control circuitry that can be configured to control the optical source 504, the circuit architecture 506, and the detectors 508. The electronic integrated circuit 512 is connected to the components on the chip 502 by a plurality of conductive structures 514. In some implementations, the chip 502 can comprise a III/V material and the plurality of conductive structures 514 can comprise metal bumps such that the chip 502 and the electronic integrated circuit 512 are connected in a bump bonded or flip-chip configuration. Other examples of bump bonding include copper pillar flip-chip or indium bump bonding.

In some implementations, one or more photonic integrated circuits comprising a III/V material can be co-packaged along with one or more silicon photonic integrated circuits that includes some fraction of a circuit architecture, such as photodetectors, modulators, and/or combination elements. In some implementations, an optical source can be separate from other components.

FIG. 5B depicts a side view of an example device 500B comprising a chip 522 of a first material. A circuit architecture is arranged in a layer of the chip 522. The chip 522 comprises a circuit architecture 526 and detectors 528 in communication with optical ports of the circuit architecture 526. The device 500B comprises an optical source 530 that is coupled into the chip 522. In some implementations, the first material can comprise a III/V material such as a composition or alloy of indium, gallium, arsenic, and phosphide (InGaAsP). An electronic integrated circuit 532 is connected to each structure of the chip 522 by a plurality of conductive structures 534.

FIG. 5C depicts an example device 500C comprising a chip 552 of a first material, i.e., a III/V material, and a chip 554 of a second material, i.e., silicon. Portions of a circuit architecture are arranged across the chip 552 and the chip 554. In this example, a portion 556 comprising optical amplification modules and optical power splitting modules is arranged in a layer of the chip 552. Phase modulation modules 558 and optical components 560 associated with recombination/feedback are arranged in a layer of the chip 554. An electronic integrated circuit 562 is configured to apply control signals to the portion 556 via a conductive structure 564, i.e., a wirebond or bumps. An optical source 566 provides optical waves to the portion 556. An electronic integrated circuit 568 is configured to apply control signals to the phase modulation modules 558 and receive control signals from the optical components 560. The electronic integrated circuit is connected to structures of the chip 554 by a plurality of conductive structures 570.

Without using the methods disclosed herein, some circuit architecture configurations can comprise a single optical amplification module configured to operate at high gain and high saturation output power. Some configurations can comprise a single SOA operating near saturation. In some examples, operating SOAs in saturation can provide diminished gain in comparison to operating SOAs below saturation. Alternatively, some SOAs can have low gain and can be operated close to saturation, whereas SOAs with high gain can pay an efficiency penalty to stay out of the saturation regime. To achieve both high gain and high saturation output power, an optical waveguide of an SOA can be designed such that the optical mode has low overlap with the active region, as saturation output power is inversely proportional to the confinement factor of the active region. This design can be associated with a lower modal gain, increasing the length of the SOA. Confinement factor can only be reduced so much before background losses in the optical waveguide start to overwhelm the modal gain and efficiency suffers. Alternatively, some SOAs can be designed to be operated at high pump currents, as increasing the pump current can improve both the gain and the saturation output power. However, pump current can only be increased up to a point beyond which SOA self-heating reduces the material gain more than increasing the pump current increases the gain.

Without using the method disclosed herein for configuring circuit architectures, another method of achieving high gain and high saturation output power can optimize a waveguide geometry of a single optical amplification module. For instance, some configurations can comprise slab-coupled optical waveguide amplifiers, where the optical mode is designed to have very low overlap with a large active region based on the waveguide structure. While this design can be effective at achieving high saturation output power and high gain, the design can be associated with reduced efficiency, as waveguide sections closer to the beginning of the amplifier can operate in the inefficient linear region of the amplifier. Such configurations can be associated with degrading the overall efficiency of the device.

Without using the methods disclosed herein for configuring circuit architectures, another method of designing circuit architecture can comprise a single SOA having a taper such that the width of the waveguide increases towards the end of the amplifier. By way of example, the optical mode at the end of the amplifier can be typically unpredictable or asymmetric in shape and can be wider than is desirable for high-efficiency coupling into single-mode waveguides. Thermal gradients within the tapered amplifier can also cause thermal lensing within the amplifier, degrading the beam quality of the output mode.

In other words, without using the methods disclosed herein, some circuit architectures can involve a single optical amplification module that can be associated with limitations. In contrast, configuring a circuit architecture comprising a plurality of optical amplification modules can distribute the amplification throughout the tree such that the plurality of optical amplification modules collectively provide an amplification. This configuration can allow for the circuit architecture to circumvent some of these limitations with operating a single optical amplification module. In particular, operating limitations associated with high powers in single elements can be avoided. This configuration can allow for the designs described above to be incorporated into a circuit architecture.

As previously discussed, some optical amplification modules can be configured as an SOA. Some circuit architecture configurations can optimize various aspects of SOA design and operation. For instance, some SOA designs can be configured to increase or maximize the efficiency, power, or gain of the overall amplifier structure. For instance, using high-confinement waveguides where the optical mode has a high overlap factor with the active medium (close to one) can shorten the length of the SOA in comparison to devices with smaller confinement factors. Some SOA designs can limit a device length for each SOA and pump current to increase the efficiency of the amplifier given a choice for a splitting ratio in the amplifier. Efficiency can be further improved by tapering the waveguide width of each individual SOA element, so that the saturation power is lower at the beginning of the SOA element and larger at the end of the SOA element.

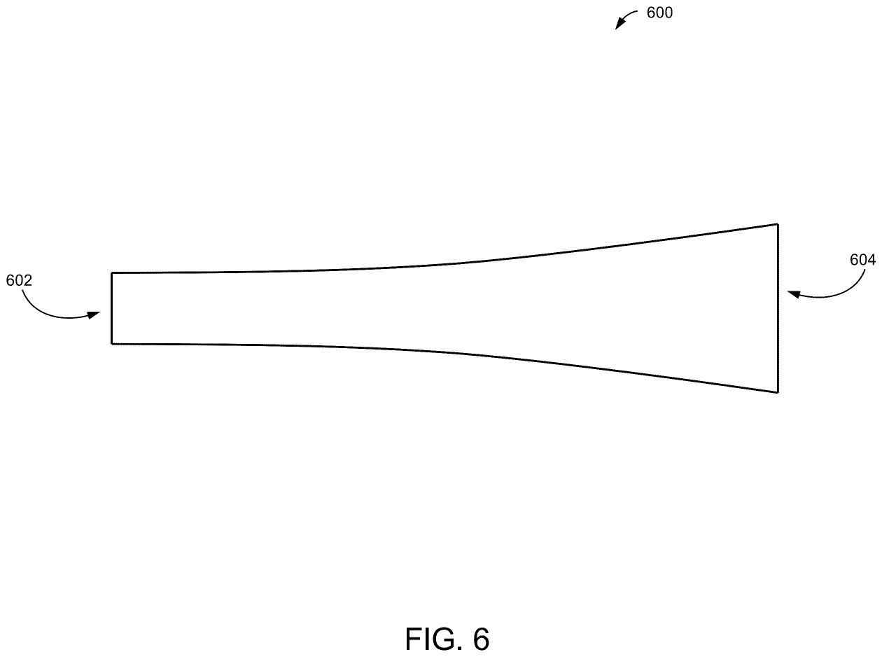

FIG. 6 depicts an example optical amplification module 600 configured as a tapered device. As shown in FIG. 6 the optical amplification module 600 comprises a first end 602 having a first width and a second end 604 having a second width. In this example, the second width is larger than the first width. As the waveguide increases in width, the saturation output power of the amplifier can also increase. This design can allow the amplifier to operate close to saturation throughout the entire length of the device, enabling devices that achieve high gain and high output power at higher efficiencies than amplifiers without a taper.

In some implementations, SOAs within the amplification tree can be designed with different geometries than other locations within the amplification tree to achieve different gains, saturation powers, efficiencies, thermal dissipation, or other parameters.

As previously described, some circuit architectures can comprise optical ports that are in optical communication with optical reflectors. Such configurations can allow a circuit architecture to be used as a gain element of an optical source. In some examples, an optical source having a gain element can be used as a laser.

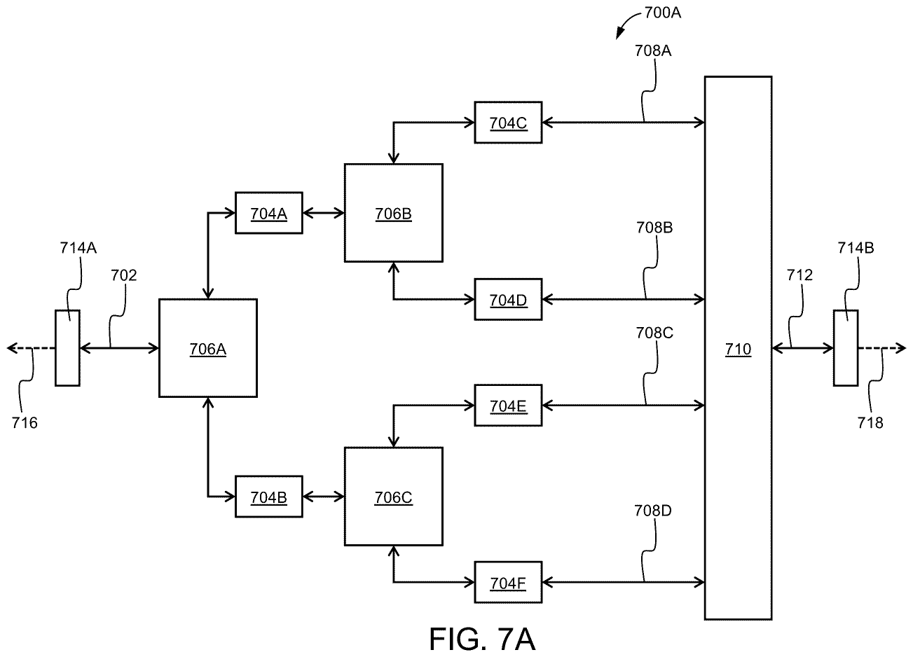

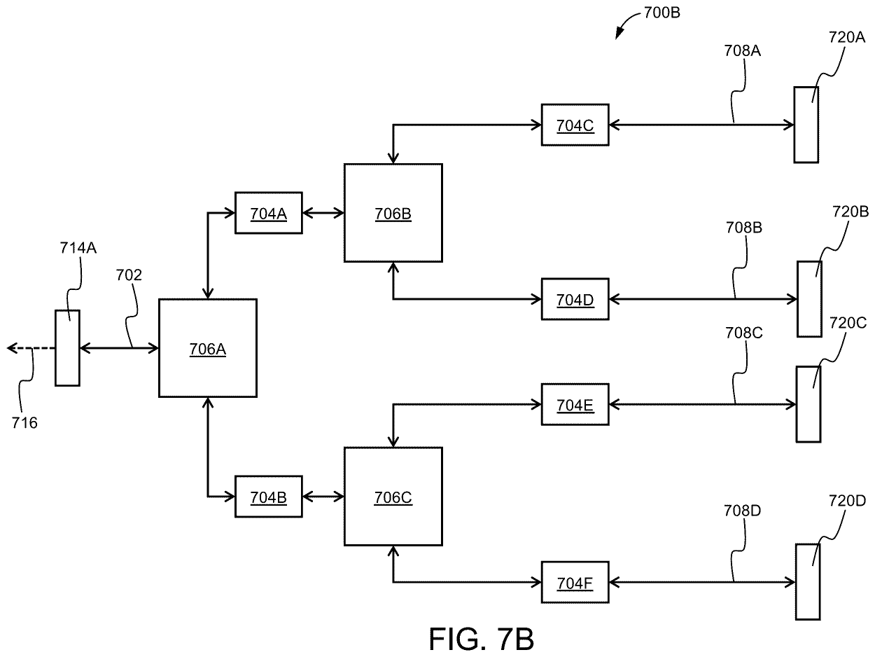

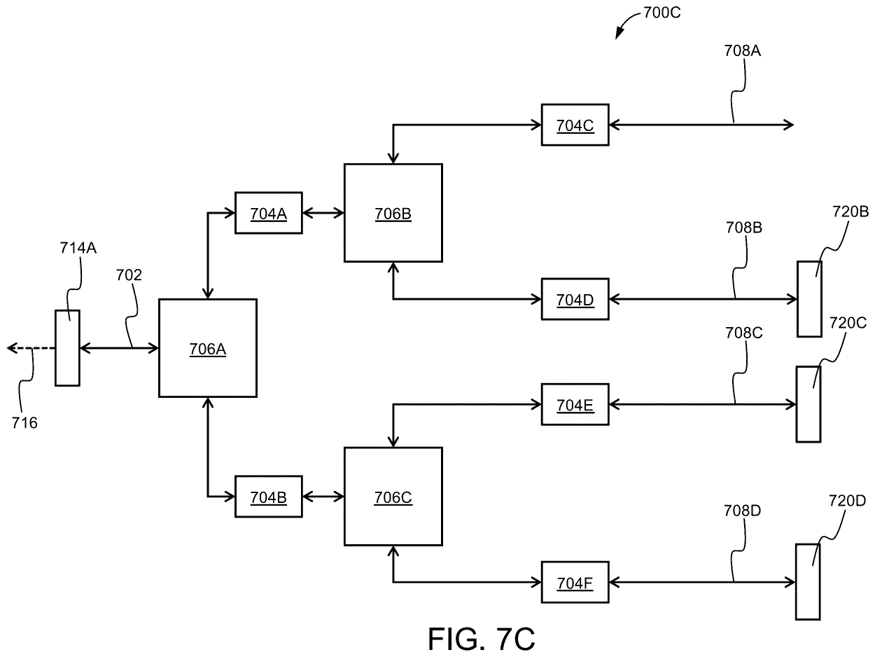

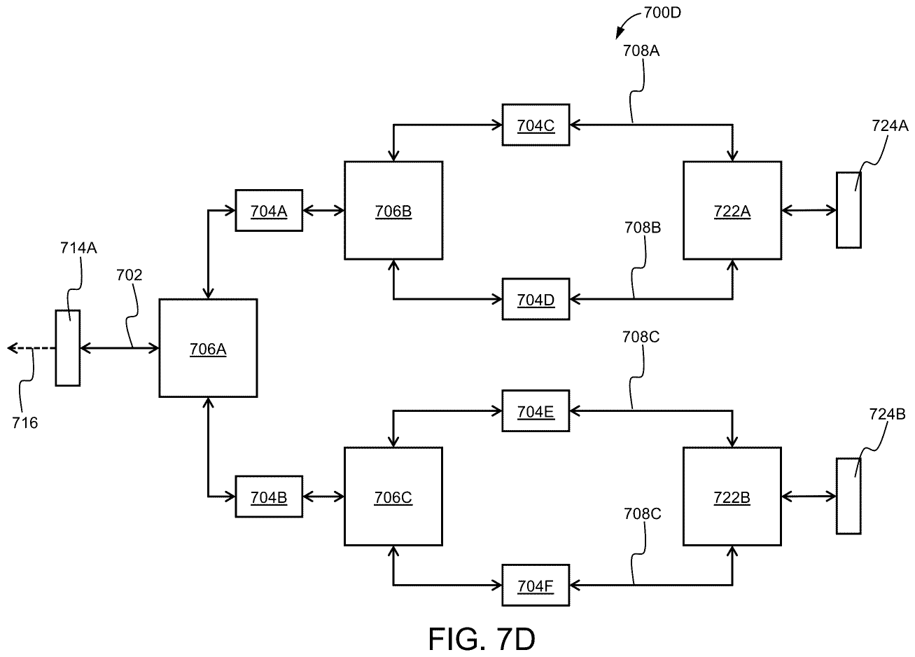

FIG. 7A depicts an example circuit architecture 700A. The circuit architecture 700A comprises an optical port 702 that is configured to provide an optical wave and receive an optical wave. The circuit architecture 700A further comprises a plurality of optical amplification modules 704A-704F, i.e., an optical amplification module 704A, an optical amplification module 704B, an optical amplification module 704C, an optical amplification module 704D, an optical amplification module 704E, and an optical amplification module 704F. The circuit architecture 700A further comprises a plurality of optical power splitting modules 706A-706C, i.e., an optical power splitting module 706A, an optical power splitting module 706B, and an optical power splitting module 706C. The circuit architecture 700A further comprises a plurality of optical ports 708A-708D, i.e., an optical port 708A, an optical port 708B, an optical port 708C, and an optical port 708D. An optical combiner 710 is in communication with each optical port of the plurality of optical ports 708A-708D. The optical combiner is provided to combine portions of optical waves from the plurality of optical ports 708A-708D into an optical wave in an optical port 712. The optical port 702 is in optical communication with an optical reflector 714A and the optical port 712 is in optical communication with an optical reflector 714B. The optical reflector 714A and the optical reflector 714B form an optical cavity such that the circuit architecture is positioned in the optical cavity. Optical waves can be coupled into the optical cavity via the optical port 702 or the optical port 712. The optical port 712 is configured to provide an optical wave to and receive a reflected optical wave from the optical reflector 714B, which propagates back through the circuit architecture to the optical port 702. Likewise, the optical port 702 is configured to provide an optical wave to and receive an optical wave from the optical reflector 714A. Optical waves propagating in the optical cavity can be amplified by the plurality of optical amplification modules 708A-708F. In some implementations, the optical reflector 714A can be at least partially transmissive such that amplified optical waves 716 escape the optical cavity. In some implementations, the optical reflector can be at least partially transmissive such that amplified optical waves 718 escape the optical cavity.

Examples of optical reflectors or reflective elements include but are not limited to: mirrors, dielectric reflectors, Bragg gratings, photonic crystal reflectors, and Sagnac loop mirrors.

In other words, as shown in FIG. 7A, some optical power splitting modules are bidirectional such that the optical power splitting module can be used as an optical power combining module.

Some optical cavities can also be formed without an optical combiner. FIG. 7B depicts an example circuit architecture 700B comprising similar optical components as the circuit architecture 700A. In this example, each optical port of the plurality of optical ports 708A-708D is in optical communication with a respective optical reflector of a plurality of optical reflectors 720A-720D, i.e., an optical reflector 720A, an optical reflector 720B, an optical reflector 720C, and an optical reflector 720D. In other words, a reflective element is positioned at an end of the tree.

In some implementations, one or more optical reflectors can be omitted to output light from a circuit architecture. FIG. 7C depicts an example circuit architecture 700C wherein the optical reflector 720A has been removed. An optical wave from the optical port 708A can be the output of the circuit architecture. Some optical cavities can comprise configurations wherein some optical ports are combined with other optical ports to reduce the number of reflectors. FIG. 7D depicts an example circuit architecture 700D. An optical combiner 722A combines a portion of an optical wave from the optical port 708A and a portion of an optical wave from the optical port 708B. An optical combiner 722B combines a portion of an optical wave from the optical port 708C and a portion of an optical wave from the optical port 708D. The optical combiner 722A and the optical combiner 722B form an optical combining arrangement. Each of the optical combiner 722A and the optical combiner 722B is in optical communication with an optical reflector 724A and an optical reflector 724B, respectively.

Similar to the examples shown in FIGS. 4A-4L, some circuit architectures configured as gain elements of lasers can comprise a plurality of phase modulation modules and one or more filtering modules distributed throughout the circuit architecture. While not shown in FIGS. 7A-7D, control circuitry can be configured to apply a control signal to components of the circuit architecture.

Some systems can comprise analog, digital, or mixed-signal circuitry configured to perform functions such as signal processing, voltage regulation, or data acquisition. Some systems can comprise interface or control circuitry configured to perform functions such as applying bias voltages, measuring voltages, or interfacing with components of the circuit. In some examples, control circuitry can be implemented in one or more dedicated regions of an IC, or distributed throughout a circuit architecture. In some examples, control circuitry can comprise components such as a field-programmable gate array (FPGA), an application specific integrated circuit (ASIC), one or more processors or processor cores, including central processing unit(s) (CPU(s)) and/or graphics processing unit(s) (GPU(s)), or other computing devices or modules capable of executing a program (e.g., software and/or firmware) comprising instructions or other compiled or executable code. The electronic circuitry can also include at least one data storage system (e.g., including volatile and non-volatile memory, and/or storage media). The program may be provided on a computer-readable storage medium, or delivered over a communication medium such as a wired or wireless network, to a device module where it can be stored and eventually executed when read by the device to perform the procedures of the program.

In some implementations, portions of a circuit architecture and control circuitry can be arranged in a flip-chip configuration to allow for three-dimensional integration of multiple chips or substrates. Some flip-chip configurations comprise conductive structure such as wire bonds, microbumps, or vias to facilitate electrical communication between multiple layers or chips.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an input port configured to receive an optical wave;
a plurality of optical amplification modules, each configured to apply a gain to an optical wave propagating through that optical amplification module;
a plurality of optical power splitting modules, each configured to provide portions of an input optical wave to each output of two or more outputs according to an optical power splitting ratio associated with that optical power splitting module; and
a plurality of optical ports, each configured to provide an optical wave;
wherein the plurality of optical power splitting modules is interconnected in a tree network that comprises:
a root stage of the tree network comprising a path segment between the input port and an input of a first optical power splitting module of the plurality of optical power splitting modules,
a final stage of the tree network comprising a plurality of path segments between a respective output of an optical power splitting module and a respective optical port of the plurality of optical ports, and
a plurality of inner stages of the tree network, each inner stage comprising a plurality of path segments between a respective output of an upstream optical power splitting module and a respective input of a downstream optical power splitting module; and
wherein at least two inner stages each include a respective optical amplification module on one or more path segments of the plurality of path segments of that inner stage.

2. The apparatus of claim 1, further comprising a plurality of phase modulation modules, where each phase modulation module of the plurality of phase modulation modules is configured to apply a phase modulation to an optical wave propagating through that phase modulation module of the plurality of phase modulation modules, and where each phase modulation module is in optical communication with an optical amplification module of the plurality of optical amplification modules or an optical power splitting module of the plurality of optical power splitting modules.

3. The apparatus of claim 2, wherein each phase modulation module of the plurality of phase modulation modules is in optical communication with an optical port of the plurality of optical ports.

4. The apparatus of claim 2, wherein each phase modulation module of the plurality of phase modulation modules is configured to apply the phase modulation in response to a control signal provided to that phase modulation module of the plurality of phase modulation modules.

5. The apparatus of claim 1, wherein one or more optical amplification modules of the plurality of optical amplification modules are further configured to apply a phase modulation to an optical wave propagating through that optical amplification module of the one or more optical amplification modules.

6. The apparatus of claim 1, wherein an optical amplification module is arranged on the path segment of the root stage of the tree network.

7. The apparatus of claim 1, wherein each optical amplification module of the plurality of optical amplification modules is configured to apply the gain to the optical wave in response to a control signal provided to that optical amplification module of the plurality of optical amplification modules.

8. The apparatus of claim 7, further comprising circuitry configured to provide a control signal to each optical amplification module of the plurality of optical amplification modules.

9. The apparatus of claim 7, wherein at least one control signal is generated based at least in part on a measurement of at least a portion of an optical wave provided to an optical port of the plurality of optical ports.

10. The apparatus of claim 1, wherein the gain that each optical amplification module of the plurality of optical amplification modules applies to an optical wave is based at least in part on an optical power splitting ratio associated with an optical power splitting module of the plurality of optical power splitting modules that provides an optical wave to that optical amplification module of the plurality of optical amplification modules.

11. The apparatus of claim 1, wherein at least one path segment along which an optical power splitting module of the plurality of optical power splitting modules provides an optical wave has an optical path length that is different from an optical path length of a path segment along which a different optical power splitting module of the plurality of optical power splitting modules provides an optical wave.

12. The apparatus of claim 1, further comprising one or more filtering modules, where each filtering module of the one or more filtering modules is configured to separate optical waves propagating through that filtering module of the one or more filtering modules, and where each filtering module of the one or more filtering modules is in optical communication with an optical amplification module of the plurality of optical amplification modules or an optical power splitting module of the plurality of optical power splitting modules.

13. The apparatus of claim 1, further comprising an optical combining arrangement configured to combine at least a portion of an optical wave from each optical port of two or more optical ports of the plurality of optical ports into one or more optical waves.

14. The apparatus of claim 13, wherein each optical port of the two or more optical ports associated with the optical combining arrangement is in optical communication with an optical reflector such that the optical combining arrangement uses one or more optical power splitting modules of the plurality of optical power splitting modules to combine optical waves.

15. The apparatus of claim 13, wherein the optical combining arrangement comprises a free-space optical combining arrangement configured to combine at least a portion of an optical wave from each optical port of the plurality of optical ports into a spatial mode of an optical wave.

16. The apparatus of claim 13, wherein the optical combining arrangement comprises a network of a plurality of optical combining modules, where each optical combining module of the plurality of optical combining modules is configured to receive at least two optical waves and combine the at least two optical waves into an optical wave.

17. The apparatus of claim 1, wherein either (1) a first optical power of an optical wave propagating along a first path segment between a first optical power splitting module and a second optical power splitting module, and before an initial optical amplification module on the first path segment, is within a factor of two of a second optical power of an optical wave propagating along a second path segment between the second optical power splitting module and an initial optical amplification module on the second path segment or (2) a first optical power of an optical wave propagating along a first path segment between a first optical power splitting module and a second optical power splitting module, and after an initial optical amplification module on the first path segment, is within a factor of two of a second optical power of an optical wave propagating along a second path segment between the second optical power splitting module and an initial optical amplification module on the second path segment.

18. The apparatus of claim 1, wherein at least a first optical amplification module that receives an optical wave over a first path from the input port through one or more optical power splitting modules is configured to apply a gain that is less than twice an inverse of an optical power splitting ratio associated with an optical power splitting module that is either (1) upstream and closer to the first optical amplification module than all other optical power splitting modules upstream on the first path or (2) downstream and closer to the first optical amplification module than all other optical power splitting modules downstream on the first path.

19. A method comprising:
arranging an input port configured to receive an optical wave;
arranging a plurality of optical amplification modules, each configured to apply a gain to an optical wave propagating through that optical amplification module;
arranging a plurality of optical power splitting modules, each configured to provide portions of an input optical wave to each output of two or more outputs according to an optical power splitting ratio associated with that optical power splitting module;
arranging a plurality of optical ports, each configured to provide an optical wave; and
configuring a tree network to interconnect the plurality of optical power splitting modules, the tree network comprising:
a root stage of the tree network comprising a path segment between the input port and an input of a first optical power splitting module of the plurality of optical power splitting modules,
a final stage of the tree network comprising a plurality of path segments between a respective output of an optical power splitting module and a respective optical port of the plurality of optical ports, and
a plurality of inner stages of the tree network, each inner stage comprising a plurality of path segments between a respective output of an upstream optical power splitting module and a respective input of a downstream optical power splitting module;
wherein at least two inner stages each include a respective optical amplification module on one or more path segments of the plurality of path segments of that inner stage.

20. The method of claim 19, wherein at least a first optical amplification module that receives an optical wave over a first path from the input port through one or more optical power splitting modules is configured to apply a gain that is less than twice an inverse of an optical power splitting ratio associated with an optical power splitting module that is either (1) upstream and closer to the first optical amplification module than all other optical power splitting modules upstream on the first path or (2) downstream and closer to the first optical amplification module than all other optical power splitting modules downstream on the first path.
